(19) United States
(12) Patent Application Publication
(10) Pub. No.: US 2023/0352746 A1
(43) Pub. Date: Nov. 2, 2023

(54) DYNAMIC CHARGE ACCEPTANCE IN LEAD ACID BATTERIES

(71) Applicant: Cabot Corporation, Boston, MA (US)

(72) Inventors: Yu-Hua Kao, Shrewsbury, MA (US); Agathagelos Kyrlidis, Cambridge, MA (US); Persefoni E. Kechagia, Lexington, MA (US); Paolina Atanassova, Munich (DE); Tushar Shah, Fulton, MD (US)

(21) Appl. No.: 18/042,832

(22) PCT Filed: Aug. 20, 2021
(86) PCT No.: PCT/US2021/046824

§ 371 Date: Feb. 24, 2023

Related U.S. Application Data
(60) Provisional application No. 63/073,241, filed on Sep. 1, 2020.
(60) Provisional application No. 63/180,131, filed on Apr. 27, 2021.

(51) Int. Cl. H01M 10/06; H01M 4/23; H01M 4/62

(52) U.S. Cl. CPC H01M 10/06; H01M 4/23; H01M 4/625; H01M 4/627

(57) ABSTRACT

A carbon-based additive for negative active materials includes carbon nanostructures free of a fiber substrate, carbon nanostructures fused to a fiber substrate or any combination thereof. In many cases, the carbon-based additive further includes carbon black. The additive is used to prepare electrode compositions for lead acid batteries. Batteries that include such electrode compositions are characterized by improved dynamic charge acceptance and lead utilization, typically at acceptable water loss levels. Some of the batteries described herein exhibit a negligible memory effect.

### INCORPORATION BY REFERENCE

This application is related to U.S. Provisional Patent Application No. 63/073,241, filed on Sep. 1, 2020 and 63/180,131, filed on Apr. 27, 2021, both of which are incorporated herein by this reference in their entirety.

### BACKGROUND OF THE INVENTION

A typical lead acid battery is an electrochemical storage battery generally comprising a positive plate, a negative plate, and an electrolyte comprising aqueous sulfuric acid. The plates are held in a parallel orientation and electrically isolated by porous separators to allow free movement of charged ions. The positive battery plates include a current collector (i.e., a metal plate or grid) covered with a layer of positive, electrically conductive lead dioxide (PbO₂) on the surface. The negative battery plates involve a current collector covered with a negative, active material, which typically contains lead (Pb) metal.

During discharge cycles, lead metal (Pb) supplied by the negative plate reacts with the ionized sulfuric acid electrolyte to form lead sulfate (PbSO₄) on the surface of the negative plate, while the PbO.sub.2 located on the positive plate is converted into PbSO₄ on or near the positive plate. During charging cycles (via an electron supply from an external electrical current), PbSO₄ on the surface of the negative plate is converted back to Pb metal, and PbSO₄ on the surface of the positive plate is converted back to PbO₂. In effect, a charging cycle converts PbSO₄ into Pb metal and PbO₂; a discharge cycle releases the stored electrical potential by converting PbO₂ and Pb metal back into PbSO₄.

Lead-acid batteries are currently produced in flooded cell and valve regulated configurations. In flooded cell batteries, the electrodes/plates are immersed in electrolyte and gases created during charging are vented to the atmosphere. Valve regulated lead-acid batteries (VRLA) include a one-way valve which prevents external gases entering the battery but allows internal gases, such as oxygen generated during charging, to escape if internal pressure exceeds a certain threshold. In VRLA batteries, the electrolyte is normally immobilized either by absorption of the electrolyte into a glass mat separator or by gelling the sulfuric acid with silica particles.

Currently the negative plates of lead-acid batteries are produced by applying a paste of micron size leady oxide powder in sulfuric acid to electrically conducting lead alloy structures known as grids. Once the plates have been cured and dried, they can be assembled into a battery and charged, thus converting to Pb sponge.

Dynamic charge acceptance (DCA) relates to the ability of a battery to accept and store energy under given external parameters like time, temperature, state-of-charge, charging voltage or battery history. This property has become an increasingly important performance parameter, in particular for vehicles with start/stop functionality or recuperation of kinetic energy. Some strategies for improving the DCA of the negative electrode involve design optimizations, leading to ultra-batteries, for instance, and the use of carbon-coated separators.

A carbon-based additive, often carbon black (CB), can be introduced to the negative plates or negative active materials, to reduce sulfonation, for example. According to some studies, such an additive can lead to improvements in dynamic charge acceptance (DCA) of about 0.5 A/Ah.

### SUMMARY OF THE INVENTION

Widely used, lead acid batteries are generally safe and can be produced at relatively low cost. Their recyclability can be 99% or more. Due to these and other features, this type of battery is being considered a viable candidate for automotive starting, lighting and ignition (SLI) and other developing applications.

With a desire for a more green and sustainable future, the need for high performance lead battery, specifically for high dynamic charging acceptance (DCA) performance in micro/mild (start-stop) automotive applications, is paramount, as more stringent regulations for carbon dioxide emission have been enacted across the globe. To this end, advanced lead batteries are playing a critical role in the journey of automotive electrification.

Although exiting carbon additives used in the preparation of lead acid batteries can bring about benefits such as electrical conductivity improvements, restriction in lead sulfate crystal growth, capacitive action and/or electrocatalytic effect on lead ion reduction, these improvements may not be sufficient to comply with evolving industry standards. For instance, present DCA targets for 12-volt start stop batteries are at about 0.3 to 0.5 A/Ah but are expected to increase over the next two or three years, to reach 1 to 1.5 A/Ah.

In addition, many of the carbon additives in current use can raise issues such as increased water loss, fast battery self-discharge, the presence of impurities, high manufacturing costs, and so forth.

Thus, a need exists for carbon-based additives having the potential to enhance the DCA performance of lead acid batteries. A need also exists for carbon-based additives that can improve lead utilization. Increasing DCA without undue water loss also is desired.

It was discovered that using a carbon-based additive that contains carbon nanostructures, optionally in conjunction with other carbonaceous materials, CB for instance, can produce lead acid batteries with very attractive characteristics. In some implementations, electrodes and/or lead acid batteries in which negative active materials are combined with carbon nanostructures display not only high DCA but also low memory effects.

As used herein, the term “carbon nanostructure” or “CNS” refers to a plurality of carbon nanotubes (CNTs), multiwall (also known as multi-walled) carbon nanotubes (MWCNTs), in many cases, that can exist as a polymeric structure by being interdigitated, branched, crosslinked, and/or sharing common walls with one another. Thus, CNSs can be considered to have CNTs, such as, for instance, MWCNTs, as a base monomer unit of their polymeric structure. Typically, CNSs are grown on a substrate (e.g., a fiber material) under CNS growth conditions. In such cases, at least a portion of the CNTs in the CNSs can be aligned substantially parallel to one another, much like the parallel CNT alignment seen in conventional carbon nanotube forests.

In some cases, the carbon nanostructures employed are free or devoid of substrate, e.g., a fiber material used to grow the carbon nanostructures. In others, the carbon nanostructures are provided on a substrate (e.g., a fiber material) and can be described as “infused” or as “coated” onto the substrate. Such substrate-containing CNS materials include at least about 0.5 weight % of fibers in combination with various amounts of carbon nanostructures. For instance, one illustrative fiber-containing CNS material comprises carbon nanostructures in an amount within a range of from about 0.5 to 3 weight %, while another illustrative fiber-containing material comprises carbon nanostructures in an amount of at least about 12 weight %, e.g., in an amount as high as about 20 weight %.

Depending on CNS content and/or the specific manufacturing process employed, substrate-containing CNS materials can be described as: (i) “CNSs-coated fibers”, “CNSs-infused fibers”, or simply “CNSs fibers” or “CNSF”; and (ii) “spent CNSs-coated fibers”, “spent CNSs-infused fibers” or simply “spent CNSs fibers” or “SCNSF”. While CNSF can be prepared by various techniques for growing CNSs and typically omit operations aimed at separating CNSs from the growth substrate, SCNSF often refer to a material recovered after CNSs have been separated from their growth substrate. Thus, while both CNSs fibers and spent CNSs fibers, contain CNSs as well as substrate material, spent CNSs fibers will typically have relatively low amounts of CNSs (especially when compared to CNSs fibers), most CNSs having been already harvested. In one illustration, CNSs fibers contain about 17 weight % CNSs, while spent CNSs fibers contain only about 2 weight %.

Many of the embodiments described herein employ combinations or “blends” of carbon nanostructures e.g., carbon nanostructures comprising essentially no substrate (e.g., less than 0.5 weight % fibers) and/or one or more substrate-containing CNS material. In one example, CNSs free or devoid of substrate, a material often referred to herein as “CNS” can be used in combination with CNSF and/or SCNSF. Another example employs a blend of CNSF and SCNSF.

In many implementations, a CNS component, including one or more types of carbon nanostructures such as described above, is combined with carbon black and/or another carbonaceous additive such as, for instance, conventional nanotubes.

Thus, in one of its aspects, the invention features an electrode composition that can be used to prepare lead acid batteries or electrodes thereof. The composition includes negative active materials (also known as a “negative active mass”) for a lead acid battery and carbon nanostructures that can be free of a substrate (e.g., a fiber), fused onto a fiber substrate, or a combination thereof. In specific implementations, the composition further includes at least one other constituent, such as, for instance, carbon black (CB), e.g., a conductive CB, carbon nanotubes (CNTs), typically conventional CNTs such as individualized MWCNTs, or combinations of CB and CNTs. The CB component can be a blend of CBs.

In another embodiment, the invention features a method for preparing a composition (often in the form of a paste) that can be employed to fabricate a negative electrode (plate) for a lead acid battery. The method includes combining carbon nanostructures with negative active materials. A typical process may involve preparing a paste using leady oxide and a carbon-based additive which includes at least one of: CNS (i.e., CNSs that are free or devoid of substrate) and a fiber-containing CNSs material. The latter can include CNSF and/or SCNSF. The carbon-based additive can further comprise CB and/or conventional CNTs.

Constituents making up the carbon-based additive (CB and one or more types of CNSs, for instance) can be preblended or added individually (simultaneously or sequentially, in any order). Other ingredients commonly used to make the composition, e.g., paste, include BaSO₄, lignosulfonate, H₂SO₄ and water. The composition can be applied onto a substrate, e.g., a metal plate or grid, dried, cured and formed into an electrode.

In some cases, mixing and/or other steps conducted to prepare the composition, negative electrode, or the lead acid battery itself can result in a breakage of an initial carbon nanostructure (whether present on or free of a growth substrate, e.g., a fiber material), resulting in a composition, electrode or battery that could also include fragments of carbon nanostructures and fractured carbon nanotubes, typically fractured multiwall carbon nanotubes. Typically, the fragments of carbon nanostructures include a plurality of multiwall carbon nanotubes that are crosslinked in a polymeric structure by being branched, interdigitated, entangled and/or sharing common walls. The fractured multiwall carbon nanotubes are derived from carbon nanostructures and are branched and share common walls with one another. These fragments or fractured species may be free of or may include growth substrate, typically a fiber material.

While for fiber-containing materials it may be possible for CNSs to become detached from the substrate, this process is expected to occur to different extents, and in some cases, not at all.

The carbon-based additive described herein can be employed in many types of lead acid batteries and may be particularly useful in applications that require cycling durability and quicker charge/discharge, such as encountered with automotive start-stop batteries, starting, lighting and ignition (SLI) batteries, industrial motive power, telecommunications, large grid scale storage for renewable energy, and so forth.

Practicing aspects of the invention can produce lead acid batteries with improved characteristics, in particular with respect to DCA, while, in many cases, also mitigating water loss. Whether isolated from their growth substrate and/or coated on fibers, carbon nanostructures appear to increase lead utilization by 10% or more, relative to carbon black.

In some embodiments, the invention features a lead acid battery having a DCA within the range of from about 0.5 to about 1.5 A/Ah or higher (measured by EN 50342-6:2015); and/or a lead utilization within a range of at least from about 170 to about 185 Ah/kg. In specific cases, water loss is maintained at acceptable levels.

Surprisingly, it was discovered that combining negative active materials with carbon nanostructures appeared to lower the history dependent DCA (memory effect) to a substantial degree. Thus, one implementation of the invention relates to a method for producing a battery with a low history dependent DCA. The method comprises: combining a negative active material for a lead acid battery with carbon nanostructure to form an electrode composition, applying the electrode composition to a substrate, and curing the electrode composition to produce a lead acid battery electrode. A lead acid battery employing such an electrode can display a memory effect that is significantly lower than that observed in a comparative lead acid battery prepared using a carbon black at the same or about the same effective STSA.

Thus, in one example, the invention features a lead acid battery characterized by Ic and Id values at 80% SOC with ΔSOC of 10% (determined according to EN 50342-6:2015 Section 7.3) that are higher than 1.5 A/Ah and that are substantially the same (within 15% or less from one another). In another example, the Id/Ic ratio is within a range of from about 1 to about 1.5, e.g., 1.2. Further examples relate to a lead acid battery that has Ic and Id values greater than 1.5 A/Ah and 2.0 A/Ah, respectively (measured at 80% SOC with ΔSOC of 20%), displaying a difference between Ic and Id (determined according to EN 50342-6:2015 Section 7.3) that is no greater than 50%.

While carbon nanotubes (CNTs) can be thought of as attractive substitutes for CB, CNSs may present some advantages over conventional (ordinary) CNTs, possibly due to the CNS unique structure. In electrodes, for instance, CNSs can promote the formation of conductive networks at lower concentrations. In many cases, CNSs-containing species present materials handling benefits that are attractive from safety, health and environmental perspectives. It is also possible that, in contrast to conventional CNTs, the CNSs “forest” can serve as a reservoir to contain extra electrolyte to promote nearby PbSO4 crystals' dissolution, which is considered a major barrier (thermodynamically and kinetically) during the charge reaction.

CNS materials are easy to manufacture, often with some flexibility regarding the level of CNSs coating on the fiber. Continuous processes are feasible using fiber spools.

In many cases, materials described herein are thought to enhance dispersity in paste formulations. Also, CNSs may provide interconnective networks (long range conductivity) in thick electrodes of 2-3 mm or more. It is believed that CNSs may function as a scaffold, thus minimizing lead particle movement and/or swelling due to repeated dissolution and deposition upon cycling.

It is also believed that materials described herein can minimize lead sulfate accumulation on the negative surface, enhancing electrolyte accessibility within the electrode. Facilitating capillary effects allows the quick exchange of electrolyte inside and outside of a thick electrode. Uniform concentration gradients/reactions across the electrode are believed to be enhanced.

Fibers present in some of the carbon-based additives (e.g., in CNSF and/or SCNSF) are thought to enhance the electrode porosity, pore size distribution, conductivity, paste processability, paste rheology, mechanical strength and/or structural integrity. The presence of fibers can reduce isolated pores in the electrode as pores are believed to be connected by fibers.

In some embodiments, the invention can be practiced with both negatives and positives. Low or stable CNS content can reduce or minimize carbon oxidation.

It is thought that impurities that may be present may be buried between fiber and carbon species and thus less prone to be exposed to external electrochemical active materials (lead, lead sulfate, electrolyte, etc.) reducing the possibility or side reactions, e.g., water loss due to the presence of impurities.

Enhancements brought about by the materials described herein also make possible the use of lower additive loadings to replicate a performance parameter that is only achieved at higher CB loadings. Similarly, improvements in lead utilization can realize manufacturing processes that consume less lead, ultimately translating in added cost benefits. Including CNS containing species can reduced active carbon content and therefore could reduce STSA, potentially reducing water loss and/or carbon material cost.

In some cases, it may be possible to prepare batteries that can maintain high DCA performances without needing to consider user history. The high efficiency for brake energy recuperation could be sustained regardless of battery cycling or aging history (which is considered a major root cause for battery failure over time).

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are diagrams illustrating differences between a Y-shaped MWCNT, not in or derived from a carbon nanostructure (FIG. 2A), and a branched MWCNT (FIG. 2B) in a carbon nanostructure;

FIGS. 2A and 2B are TEM images showing features characterizing multiwall carbon nanotubes found in carbon nanostructures;

FIGS. 2C and 2D are SEM images of carbon nanostructures showing the presence of multiple branches;

FIG. 3A is an illustrative depiction of a carbon nanostructure flake material after isolation of the carbon nanostructure from a growth substrate;

FIG. 3B is a SEM image of an illustrative carbon nanostructure obtained as a flake material;

FIG. 4 is a SEM image of CNS fibers.

FIGS. 5A and 5B are SEM images of spent CNS fibers at two different magnifications;

FIGS. 6A, 6B, 6C and 6D are SEM images of an electrode (after paste mixing and electrode forming) prepared using CNS fibers.

FIG. 7 is a series of plots of EN DCA (A/Ah) versus cycle #performed according to Test Standard EN50342 6:2015, Section: 7.3, showing dynamic charge acceptance for two formulations according to embodiments of the invention;

FIG. 8 is a series of plots showing EN DCA (A/Ah) as a function of effective STSA for several formulations prepared according to embodiments of the invention;

FIG. 9 is a series of plots showing the lead utilization (Ah/kg) as a function of effective STSA (m²/g) for several formulations prepared according to embodiments of the invention;

FIG. 10 is a series of plots showing the one-week overcharge capacity (Ah) as a function of effective STSA for several formulations prepared according to embodiments of the invention;

FIG. 11A is a bar graph showing the DC resistance (mohm) in terms of Ic, Id and Ir for several formulations prepared according to embodiments of the invention;

FIG. 11B is a series of plots showing the DC resistance (mohm) as a function of days of regenerative braking for several formulations prepared according to embodiments of the invention;

FIG. 12A is a series of plots showing the accumulated pore volume (cc/g) as a function of pore size (microns or μm) for several formulations prepared according to embodiments described herein and for a CB only formulation;

FIG. 12B is a series of plots of the differential intrusion (μmml/g) versus pore size (μm) for formulations prepared according to embodiments described herein and compared to a CB only formulation;

FIG. 13 is a SEM image showing uniform particles formed after discharge cycles at 80% SOC;

FIG. 14 is an SEM image for CNS/NAM, showing branched CNS material covering and connecting NAM particles;

FIG. 15 presents DCA data measured by DCApp (20 cycles for each interval) for various charging or discharging histories (Ic being defined as DCApp measured after charge history and Id after discharge history);

FIG. 16 presents results for DCA measured from twenty DCApp cycles for each interval, averaged and normalized with the baseline at ΔSOC=+100% (ΔSOC=SOC_{END}−SOC_{START}=80%−(−20%) SOC for the baseline).

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention generally relates to lead acid batteries, and, in particular, to a carbon-based additive for electrode compositions, e.g., electrode compositions that also include NAM.

In some of its aspects, the invention features compositions, electrodes and/or lead acid batteries including them that are prepared using carbon nanostructures and, in many cases, carbon black and/or conventional nanotubes.

As used herein, the term “carbon nanostructures” (CNSs, singular CNS) refers to a plurality of carbon nanotubes (CNTs) that are crosslinked in a polymeric structure by being branched, e.g., in a dendrimeric fashion, interdigitated, entangled and/or sharing common walls with one another. Operations conducted to prepare the compositions, electrodes and/or batteries described herein can generate CNS fragments and/or fractured CNTs. Fragments of CNSs are derived from CNSs and, like the larger CNS, include a plurality of CNTs that are crosslinked in a polymeric structure by being branched, interdigitated, entangled and/or sharing common walls. Fractured CNTs are derived from CNSs, are branched and share common walls with one another.

Highly entangled CNSs are macroscopic in size and can be considered to have a carbon nanotube (CNT) as a base monomer unit of its polymeric structure. For many CNTs in the CNS structure, at least a portion of a CNT sidewall is shared with another CNT. While it is generally understood that every carbon nanotube in the CNS need not necessarily be branched, crosslinked, or share common walls with other CNTs, at least a portion of the CNTs in the carbon nanostructure can be interdigitated with one another and/or with branched, crosslinked, or common-wall carbon nanotubes in the remainder of the carbon nanostructure.

As known in the art, carbon nanotubes (CNT or CNTs plural) are carbonaceous materials that include at least one sheet of sp²-hybridized carbon atoms bonded to each other to form a honey-comb lattice that forms a cylindrical or tubular structure. The carbon nanotubes can be single-walled carbon nanotubes (SWCNTs) or multi-walled carbon nanotubes (MWCNTs). SWCNTs can be thought of as an allotrope of sp²-hybridized carbon similar to fullerenes. The structure is a cylindrical tube including six-membered carbon rings. Analogous MWCNTs, on the other hand, have several tubes in concentric cylinders. The number of these concentric walls may vary, e.g., from 2 to 25 or more. Typically, the diameter of MWNTs may be 10 nm or more, in comparison to 0.7 to 2.0 nm for typical SWNTs.

In many of the CNSs used in this invention, the CNTs are MWCNTs, having, for instance, at least 2 coaxial carbon nanotubes. The number of walls present, as determined, for example, by transmission electron microscopy (TEM), at a magnification sufficient for analyzing the number of wall in a particular case, can be within the range of from 2 to 30 or so, for example: 4 to 30; 6 to 30; 8 to 30; 10 to 30; 12 to 30; 14 to 30; 16 to 30; 18 to 30; 20 to 30; 22 to 30; 24 to 30; 26 to 30; 28 to 30; or 2 to 28; 4 to 28; 6 to 28; 8 to 28; 10 to 28; 12 to 28; 14 to 28; 16 to 28; 18 to 28; 20 to 28; 22 to 28; 24 to 28; 26 to 28; or 2 to 26; 4 to 26; 6 to 26; 8 to 26; 10 to 26; 12 to 26; 14 to 26; 16 to 26; 18 to 26; 20 to 26; 22 to 26; 24 to 26; or 2 to 24; 4 to 24; 6 to 24; 8 to 24; 10 to 24; 12 to 24; 14 to 24; 16 to 24; 18 to 24; 20 to 24; 22 to 24; or 2 to 22; 4 to 22; 6 to 22; 8 to 22; 10 to 22; 12 to 22; 14 to 22; 16 to 22; 18 to 22; 20 to 22; or 2 to 20; 4 to 20; 6 to 20; 8 to 20; 10 to 20; 12 to 20; 14 to 20; 16 to 20; 18 to 20; or 2 to 18; 4 to 18; 6 to 18; 8 to 18; 10 to 18; 12 to 18; 14 to 18; 16 to 18; or 2 to 16; 4 to 16; 6 to 16; 8 to 16; 10 to 16; 12 to 16; 14 to 16; or 2 to 14; 4 to 14; 6 to 14; 8 to 14; 10 to 14; 12 to 14; or 2 to 12; 4 to 12; 6 to 12; 8 to 12; 10 to 12; or 2 to 10; 4 to 10; 6 to 10; 8 to 10; or 2 to 8; 4 to 8; 6 to 8; or 2 to 6; 4-6; or 2 to 4.

Since a CNS is a polymeric, highly branched and crosslinked network of CNTs, at least some of the chemistry observed with individualized CNTs may also be carried out on the CNS. In addition, some of the attractive properties often associated with using CNTs also are displayed in materials that incorporate CNSs. These include, for example, electrical conductivity, attractive physical properties including good tensile strength when integrated into a composite, such as a thermoplastic or thermoset compound, thermal stability (sometimes comparable to that of diamond crystals or in-plane graphite sheets) and/or chemical stability, to name a few.

However, as used herein, the term “CNS” is not a synonym for individualized, un-entangled structures such as “monomeric” fullerenes (the term “fullerene” broadly referring to an allotrope of carbon in the form of a hollow sphere, ellipsoid, tube, e.g., a carbon nanotube, and other shapes). In fact, many embodiments of the invention highlight differences and advantages observed or anticipated with the use of CNSs as opposed to the use of their CNTs building blocks. Without wishing to be held to a particular interpretation, it is believed that the combination of branching, crosslinking, and wall sharing among the carbon nanotubes in a CNS reduces or minimizes the van der Waals forces that are often problematic when using individual carbon nanotubes in a similar manner.

In addition, or alternatively to performance attributes, CNTs that are part of or are derived from a CNS can be characterized by a number of features, at least some of which can be relied upon to distinguish them from other nanomaterials, such as, for instance, ordinary CNTs (namely CNTs that are not derived from CNSs and can be provided as individualized, pristine or fresh CNTs).

In many cases, a CNT present in or derived from a CNS has a typical diameter of 100 nanometers (nm) or less, such as, for example, within the range of from about 5 to about 100 nm, e.g., within the range of from about 10 to about 75, from about 10 to about 50, from about 10 to about 30, from about 10 to about 20 nm.

In specific embodiments, at least one of the CNTs has a length that is equal to or greater than 2 microns, as determined by SEM. For example, at least one of the CNTs will have a length within a range of from 2 to 2.25 microns; from 2 to 2.5 microns; from 2 to 2.75 microns; from 2 to 3.0 microns; from 2 to 3.5 microns; from 2 to 4.0 microns; or from 2.25 to 2.5 microns; from 2.25 to 2.75 microns; from 2.25 to 3 microns; from 2.25 to 3.5 microns; from 2.25 to 4 microns; or from 2.5 to 2.75 microns; from 2.5 to 3 microns; from 2.5 to 3.5 microns; from 2.5 to 4 microns; or from 3 to 3.5 microns; from 3 to 4 microns; of from 3.5 to 4 microns or higher. In some embodiments, more than one, e.g., a portion such as a fraction of at least about 0.1%, at least about 1%, at least about 10%, at least about 15%, at least about 20%, at least about 25%, at least about 30%, at least about 35%, at least about 40, at least about 45%, at least about 50% or even more than one half, of the CNTs, as determined by SEM, can have a length greater than 2 microns, e.g., within the ranges specified above.

The morphology of CNTs present in a CNS, in a fragment of a CNS or in a fractured CNT derived from a CNS will often be characterized by a high aspect ratio, with lengths typically more than 100 times the diameter, and in certain cases much higher. For instance, in a CNS (or CNS fragment), the length to diameter aspect ratio of CNTs can be within a range of from about 200 to about 1000, such as, for instance, from 200 to 300; from 200 to 400; from 200 to 500; from 200 to 600; from 200 to 700; from 200 to 800; from 200 to 900; or from 300 to 400; from 300 to 500; from 300 to 600; from 300 to 700; from 300 to 800; from 300 to 900; from 300 to 1000; or from 400 to 500; from 400 to 600; from 400 to 700; from 400 to 800; from 400 to 900; from 400 to 1000; or from 500 to 600; from 500 to 700; from 500 to 800; from 500 to 900; from 500 to 1000; or from 600 to 700; from 600 to 800; from 600 to 900; from 600 to 1000; from 700 to 800; from 700 to 900; from 700 to 1000; or from 800 to 900; from 800 to 1000; or from 900 to 1000.

It has been found that in CNSs, as well as in structures derived from CNSs (e.g., in fragments of CNSs or in fractured CNTSs) at least one of the CNTs is characterized by a certain “branch density”. As used herein, the term “branch” refers to a feature in which a single carbon nanotube diverges into multiple (two or more), connected multiwall carbon nanotubes. One embodiment has a branch density according to which, along a two-micrometer length of the carbon nanostructure, there are at least two branches, as determined by SEM. Three or more branches also can occur

Further features (detected using TEM or SEM, for example) can be used to characterize the type of branching found in CNSs relative to structures such as Y-shaped CNTs that are not derived from CNSs. For instance, whereas Y-shaped CNTs, have a catalyst particle at or near the area (point) of branching, such a catalyst particle is absent at or near the area of branching occurring in CNSs, fragments of CNSs or fractured CNTs.

In addition, or in the alternative, the number of walls observed at the area (point) of branching in a CNS, fragment of CNS or fractured CNTs, differ from one side of the branching (e.g., before the branching point) to the other side of this area (e.g., after or past the branching point). Such a change in in the number of walls, also referred to herein as an “asymmetry” in the number of walls, is not observed with ordinary Y-shaped CNTs (where the same number of walls is observed in both the area before and the area past the branching point).

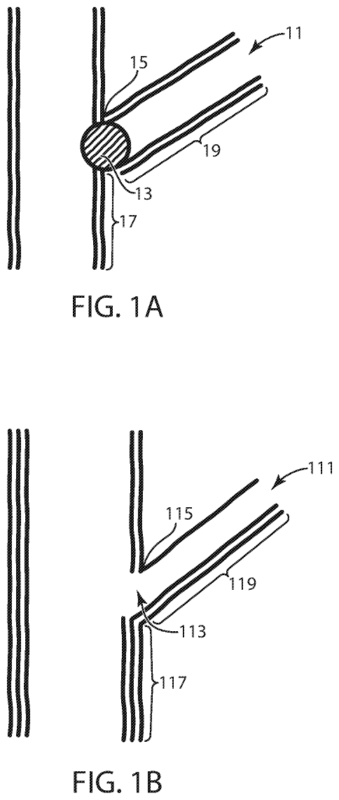

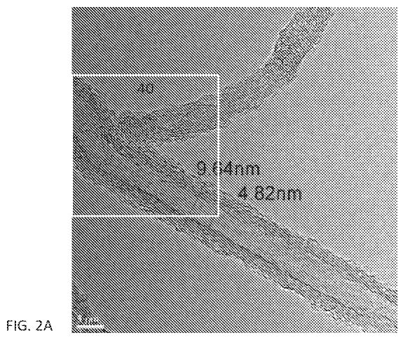

Diagrams illustrating these features are provided in FIGS. 1A and 1B. Shown in FIG. 1A, is an exemplary Y-shaped CNT 11 that is not derived from a CNS. Y-shaped CNT 11 includes catalyst particle 13 at or near branching point 15. Areas 17 and 19 are located, respectively, before and after the branching point 15. In the case of a Y-shaped CNT such as Y-shaped CNT 11, both areas 17 and 19 are characterized by the same number of walls, i.e., two walls in the drawing.

In contrast, in a CNS (FIG. 1B), a CNT building block 111, that branches at branching point 115, does not include a catalyst particle at or near this point, as seen at catalyst devoid region 113. Furthermore, the number of walls present in region 117, located before, prior (or on a first side of) branching point 115 is different from the number of walls in region 119 (which is located past, after or on the other side relative to branching point 115. In more detail, the three-walled feature found in region 117 is not carried through to region 119 (which in the diagram of FIG. 1B has only two walls), giving rise to the asymmetry mentioned above.

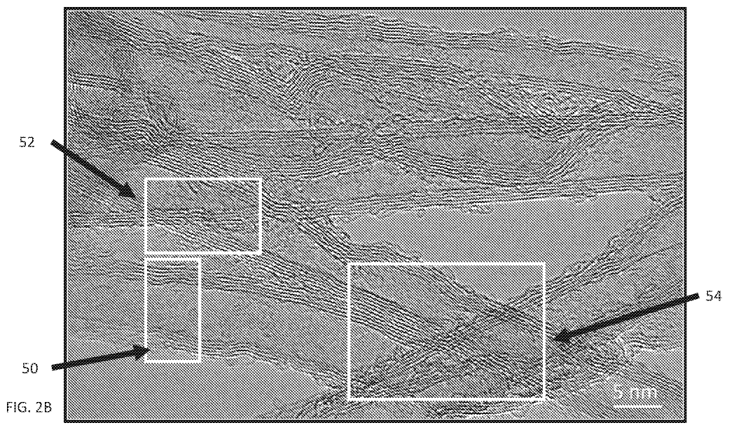

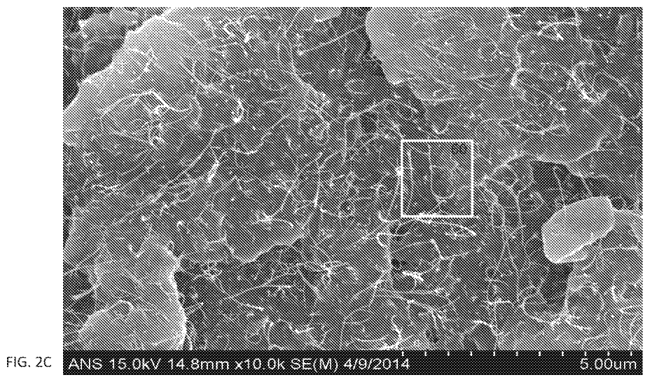

These features are highlighted in the TEM images of FIGS. 2A and 2B and SEM images of FIGS. 2C and 2D.

In more detail, the CNS branching in TEM region 40 of FIG. 2A shows the absence of any catalyst particle. In the TEM of FIG. 2B, first channel 50 and second channel 52 point to the asymmetry in the number of walls featured in branched CNSs, while arrow 54 points to a region displaying wall sharing. Multiple branches are seen in the SEM regions 60 and 62 of FIGS. 2C and 2D, respectively.

One, more, or all these attributes can be encountered in the compositions (e.g., dispersions, slurries, pastes, solid or dried compositions, etc.), electrodes and/or batteries described herein.

In some embodiments, the CNS is present as part of an entangled and/or interlinked network of CNSs. Such an interlinked network can contain bridges between CNSs.

Details regarding the preparation of CNSs can be found, for example, in U.S. Patent Application Publication No. 2014/0093728 A1, published on Apr. 3, 2014, in U.S. Pat. Nos. 5,687,212; 8,580,342; 8,784,937B2; 8,815,341; 9,005,755B2; 9,107,292B2; 9,447,259B2; and in US Patent Application Publication No. 2012/0263935. These documents, in their entirety, are incorporated herein by this reference.

In one manufacturing approach, a CNS is grown on a suitable substrate, for example on a catalyst-treated fiber material. The growth substate can be a glass or ceramic growth substrate. Growth substrates that are metals, organic polymers (e.g., aramid), basalt fibers, carbon fibers, to name a few, also can be employed. In some cases, the growth substrate is of spoolable dimensions, thereby allowing formation of the carbon nanostructure to take place continuously on the growth substrate as the growth substrate is conveyed from a first location to a second location. Other forms of growth substrate include fibers, tows, yarns, woven and non-woven fabrics, sheets, tapes, belts and the like. Tows and yarns can be particularly convenient for continuous syntheses.

CNSs can be separated from the substrate (by a fluid shearing technique, for example) to produce a substrate free material in the form of flakes. As seen, for instance, in US 2014/0093728A1, a carbon nanostructure flake material can be thought of as a discrete particle having finite dimensions and existing as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the CNS can be modulated to some degree by adjusting the carbon nanostructure growth conditions, including, for example, by changing the concentration of transition metal nanoparticle catalyst particles that are disposed on the growth substrate to initiate carbon nanotube growth.

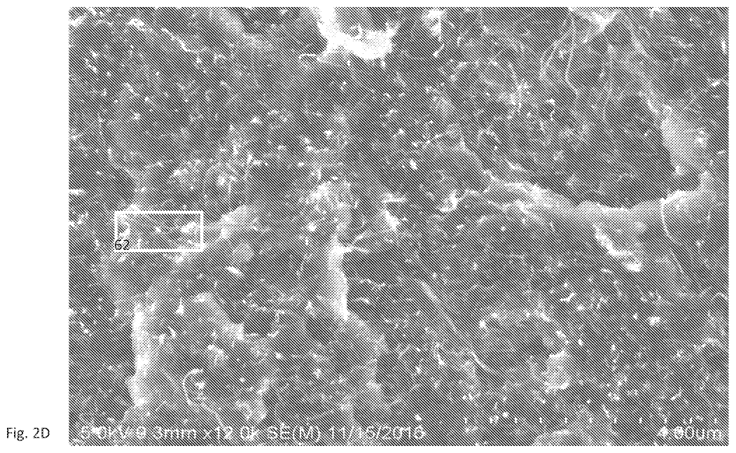

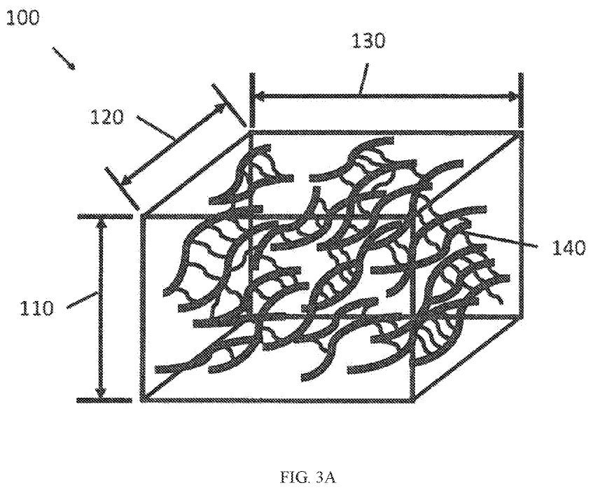

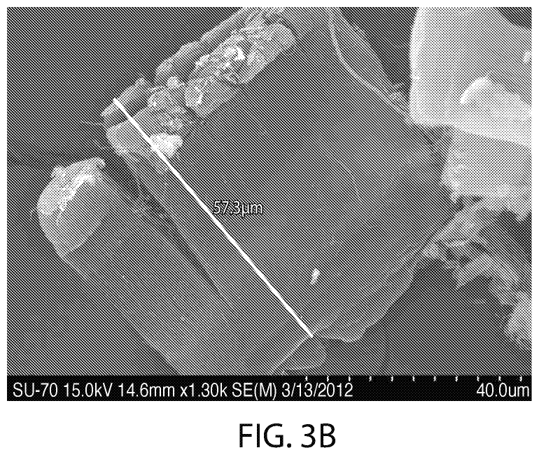

An illustrative depiction of a CNS flake material, after isolation of the CNS from a growth substrate, is shown in FIG. 3A. As seen in this figure, flake structure 100 can have first dimension 110 that is in a range from about 1 nm to about 35 μm thick, particularly about 1 nm to about 500 nm thick, including any value in between and any fraction thereof. Flake structure 100 can have second dimension 120 that is in a range from about 1 micron to about 750 microns tall, including any value in between and any fraction thereof. Flake structure 100 can have third dimension 130 that can be in a range from about 1 micron to about 750 microns, including any value in between and any fraction thereof. Two or all of dimensions 110, 120 and 130 can be the same or different.

For example, in some embodiments, second dimension 120 and third dimension 130 can be, independently, on the order of about 1 micron to about 10 microns, or about 10 microns to about 100 microns, or about 100 microns to about 250 microns, from about 250 to about 500 microns, or from about 500 microns to about 750 microns.

CNTs within the CNS can vary in length from about 10 nanometers (nm) to about 750 microns (μm), or higher. Thus, the CNTs can be from 10 nm to 100 nm, from 10 nm to 500 nm; from 10 nm to 750 nm; from 10 nm to 1 micron; from 10 nm to 1.25 micron; from 10 nm to 1.5 micron; from 10 nm to 1.75 micron; from 10 nm to 2 micron; or from 100 nm to 500 nm, from 100 nm to 750 nm; from 100 nm to 1 micron; from 100 to 1.25 micron; from 100 to 1.5 micron; from 100 to 1.75 micron from 100 to 2 microns; from 500 nm to 750 nm; from 500 nm to 1 micron; from 500 nm to 1 micron; from 500 nm to 1.25 micron; from 500 nm to 1.5 micron; from 500 nm to 1.75 micron; from 500 nm to 2 micron; from 750 nm to 1 micron; from 750 nm to 1.25 micron; from 750 nm to 1.5 micron; from 750 nm to 1.75 microns; from 750 nm to 2 microns; from 1 micron to 1.25 micron; from 1.0 micron to 1.5 micron; from 1 micron to 1.75 micron; from 1 micron to 2 microns; or from 1.25 micron to 1.5 micron; from 1.25 micron to 1.75 micron; from 1 micron to 2 microns; or from 1.5 to 1.75 micron; from 1.5 to 2 micron; or from 1.75 to 2 microns.

In specific embodiments, at least one of the CNTs has a length that is equal to or greater than 2 microns, as determined by SEM. For example, at least one of the CNTs will have a length within a range of from 2 to 2.25 microns; from 2 to 2.5 microns; from 2 to 2.75 microns; from 2 to 3.0 microns; from 2 to 3.5 microns; from 2 to 4.0 microns; or from 2.25 to 2.5 microns; from 2.25 to 2.75 microns; from 2.25 to 3 microns; from 2.25 to 3.5 microns; from 2.25 to 4 microns; or from 2.5 to 2.75 microns; from 2.5 to 3 microns; from 2.5 to 3.5 microns; from 2.5 to 4 microns; or from 3 to 3.5 microns; from 3 to 4 microns; of from 3.5 to 4 microns or higher.

Shown in FIG. 3B is a SEM image of an illustrative carbon nanostructure obtained as a flake material. The carbon nanostructure shown in FIG. 3B exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the carbon nanostructure can be modulated to some degree by adjusting the carbon nanostructure growth conditions, including, for example, by changing the concentration of transition metal nanoparticle catalyst particles that are disposed on the growth substrate to initiate carbon nanotube growth.

A flake structure can include a webbed network of carbon nanotubes in the form of a carbon nanotube polymer (i.e., a “carbon nanopolymer”) having a molecular weight in a range from about 15,000 g/mol to about 150,000 g/mol, including all values in between and any fraction thereof. In some cases, the upper end of the molecular weight range can be even higher, including about 200,000 g/mol, about 500,000 g/mol, or about 1,000,000 g/mol. The higher molecular weights can be associated with carbon nanostructures that are dimensionally long. The molecular weight can also be a function of the predominant carbon nanotube diameter and number of carbon nanotube walls present within the carbon nanostructure. The crosslinking density of the carbon nanostructure can range between about 2 mol/cm³ to about 80 mol/cm³. Typically, the crosslinking density is a function of the carbon nanostructure growth density on the surface of the growth substrate, the carbon nanostructure growth conditions and so forth. It should be noted that the typical CNS structure, containing many, many CNTs held in an open web-like arrangement, removes Van der Wall's forces or diminishes their effect. This structure can be exfoliated more easily, which makes many additional steps of separating them or breaking them into branched structures unique and different from ordinary CNTs.

With a web-like morphology, carbon nanostructures can have relatively low bulk densities. As-produced carbon nanostructures can have an initial bulk density ranging between about 0.003 g/cm³ to about 0.015 g/cm³. Further consolidation and/or coating to produce a carbon nanostructure flake material or like morphology can raise the bulk density to a range between about 0.1 g/cm³ to about 0.15 g/cm³. In some embodiments, optional further modification of the carbon nanostructure can be conducted to further alter the bulk density and/or another property of the carbon nanostructure. In some embodiments, the bulk density of the carbon nanostructure can be further modified by forming a coating on the carbon nanotubes of the carbon nanostructure and/or infiltrating the interior of the carbon nanostructure with various materials. Coating the carbon nanotubes and/or infiltrating the interior of the carbon nanostructure can further tailor the properties of the carbon nanostructure for use in various applications. Moreover, forming a coating on the carbon nanotubes can desirably facilitate the handling of the carbon nanostructure. Further compaction can raise the bulk density to an upper limit of about 1 g/cm³, with chemical modifications to the carbon nanostructure raising the bulk density to an upper limit of about 1.2 g/cm³.

Many embodiments described herein use CNSs that have a 97% or higher CNT purity. Typically, anionic, cationic or metal impurities are very low, e.g., in the parts per million (ppm) range. Often, the CNSs used herein require no further additives to counteract Van der Waals' forces.

While the carbon-based additive can include carbon nanostructures that are free or devoid of a growth substrate such as fibers, i.e., comprising fiber in an amount that is less than 1 weight %, e.g., less than 0.5 weight %, some embodiments of the invention are practiced with carbon nanostructures provided in conjunction with a substrate material, fibers, for instance. Thus, in general, the CNS component in the carbon-based additive can be thought of as containing various amounts of a substrate (typically a fiber material employed to grow the carbon nanostructures). The amounts can range from no substrate being present (i.e., carbon nanostructures that have less than 1 weight %, e.g., less than 0.9, 0.8, 0.7, 0.6, 0.5, 0.4, 0.3, 0.2 or 0.1 amounts of a substrate such as a fiber, measured by thermogravimetric analysis (TGA), and referred to herein as nanostructures that are free or devoid of substrate (fiber) or simply as CNS), to a material in which CNSs are coated or infused onto the substrate (fiber).

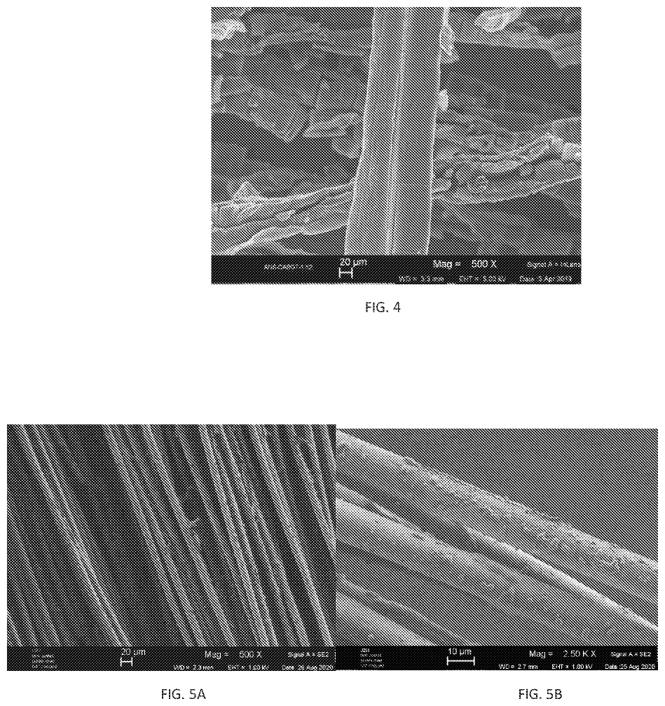

This latter substrate-containing CNS material (typically fiber-containing CNS material) can be obtained by various manufacturing approaches, approaches that can yield products in different forms, both in terms of the growth of the carbon nanostructures on the substrate as well as the distribution of the carbon nanostructures on the substrate. For instance, CNSs can infuse or coat a fiber substrate uniformly or cover the fiber in a less uniform, even patchy distribution. SEM images of illustrative substrate-containing CNS materials are shown in FIGS. 4A through 5B.

With respect to its composition, a substrate-containing CNS material can include fiber in an amount within the range of from about 70 to about 99 weight %, e.g., within a range of from about 80 to about 99%. In specific implementations, the fiber content in the substrate-containing CNS material is within a range of from 75 to 80, 75 to 85, 75 to 90, 75 to 95, 75 to 99 weight %; or from 80 to 85, 80 to 90, 80 to 95, 80 to 99 weight %; or from 85 to 90, from 85 to 95, from 85 to 99 weight %; or from 90 to 95, from 90 to 99 weight %; or from 95 to 99 weight %. Fiber content can be determined by thermogravimetry analysis (TGA), using, for instance, a standard furnace burn off test, e.g., ASTM D-3171.

Typically, amounts of carbon nanostructures present on the substrate can be as low as about 0.5 weight % and as high as about 20 weight %. In specific implementations, carbon nanostructures present on the substrate can be at 19, 18, 17, 16, 15, 14, 13, 12, 11, 10, 9, 8, 7, 6, 5, 4, 3, 2, 1 or 0.5 weight %. An illustrative substrate-containing CNS material can include carbon nanostructures in an amount within a range of from about 12 to about 16 weight %, e.g., within a range of from 12 to 13, from 12 to 14, from 12 to 15; or from 13 to 14, from 13 to 15, from 13 to 16; or from 14 to 15, from 14 to 16; or from 15 to 16 weight %. Amounts of CNSs can be lower and, in another illustrative substrate-containing CNS material, these amounts can be less than or equal to 3 weight %, e.g., within a range of from about 0.5 to about 3, e.g., from 0.5 to 1, from 0.5 to 1.5, from 0.5 to 2, from 0.5 to 2.5; or from 1 to 1.5, from 1 to 2, from 1 to 2.5, from 1 to 3; or from 1.5 to 2, from 1.5 to 2.5, from 1.5 to 3; or from 2 to 2.5, from 2 to 3; or from 2.5 to 3 weight %. Techniques that can be used to determine CNS contents include TGA and/or carbon elemental analysis.

In one example, the substrate-containing CNS material has about 20 weight % of carbon nanostructures uniformly infused onto a glass fiber substrate. In another example, the substrate-containing CNS material has about 2 weight % of carbon nanostructures distributed in a patchy coverage of the substrate.

In terms of methods of manufacture, production processes that grow CNSs on a substrate and do not involve separating the CNSs from the substrate employed can yield a material referred to herein as “CNSs-coated fibers”, “CNSs-infused fibers” or simply as “CNSs fibers” and abbreviated as “CNSF”. In some implementations, the amounts of fiber present in CNSF are within a range of from about 75 weight % to about 95 weight %, e.g., within the range of from about 80 to about 90 weight %. In specific instances, the fiber content in the CNSF material will be within a range of from about 80 to 85, 80 to 90, 80 to 95; or from 85 to 90, from 85 to 95; or from 90 to 95. With respect to carbon nanostructures, CNSF typically contain CNSs in an amount that can be as high as about 20 weight %, e.g., within a range of from about 5 to about 20, and in particular within a range of from about 12 to about 17, such as, within a range of from 12 to 13, from 12 to 14, from 12 to 15, from 12 to 16; or from 13 to 14, from 13 to 15, from 13 to 16 or from 13 to 17; of from 14 to 15, from 14 to 16, from 14 to 17; or from 15 to 16, from 15 to 17; or from 16 to 17 weight %. In some implementations, CNSF illustrate contributions brough about by a substrate-containing CNSs material having a relatively high CNS content.

Contributions observed at relatively low CNS contents can be illustrated by a substrate-containing CNS material obtained post harvesting, by recovering “waste” growth substrate left behind after the separation of substrate-free CNSs, by fluid shearing, for instance. In spite of the relatively small amounts of CNSs present, typically no greater than about 5 weight %, e.g., within a range of from about 0.5 to about 5 (the major portion of CNSs having been harvested), it was discovered that these “spent CNSs fibers”, abbreviated as SCNSF and also referred to herein as “spent CNSs-coated fibers” or “spent CNSs-infused fibers”, can still provide benefits when used in the composition, electrodes and batteries described herein. In some implementations, SCNSF contain fibers in an amount within a range of from about 85 to about 95 weight %, e.g., within a range of from about 85 to 90 or from 90 to 95. SCNSF can contain carbon nanostructures in an amount within a range of from about 0.5 to about 5 weight %, e.g., within a range of from 0.5 to 1, from 0.5 to 1.5, from 0.5 to 2, from 0.5 to 2.5, from 0.5 to 3, from 0.5 to 3.5, from 0.5 to 4, from 0.5 to 4.5; or from 1 to 1.5, from 1 to 2, from 1 to 2.5, from 1 to 3, from 1 to 3.5, from 1 to 4, from 1 to 4.5, from 1 to 5; or from 1.5 to 2, from 1.5 to 2.5 or from 1.5 to 3, from 1.5 to 3.5, from 1.5 to 4, from 1.5 to 4.5, from 1.5 to 5; or from 2 to 2.5, from 2 to 3; from 2 to 3.5, from 2 to 4, from 2 to 4.5, from 2 to 5; or from 2.5 to 3, from 2.5 to 3.5, from 2.5 to 4, from 2.5 to 4.5, from 2.5 to 5; or from 3 to 3.5, from 3 to 4, from 3 to 4.5, from 3 to 5; or from 3.5 to 4, from 3.5 to 4.5, from 3.5 to 5; or from 4 to 4.5, from 4 to 5; or from 4.5 to 5 weight %.

Some types of fibers that can be present in substrate-containing CNS materials are shown in Table 1 below.

TABLE 1

| | A | C | D | E | | AR | R | S-2 |
|---|---|---|---|---|---|---|---|---|
| | GLASS | GLASS | GLASS | GLASS | ECRGlas ® | GLASS | GLASS | GLASS ® |
| Oxide | % | % | % | % | % | % | % | % |
| SiO₂ | 63-72 | 63-68 | 72-75 | 52-56 | 54-62 | 55-75 | 55-60 | 64-66 |
| Al₂O₃ | 0-6 | 3-5 | 0-1 | 12-16 | 9-15 | 0-5 | 23-28 | 24-25 |
| B₂O₃ | 0-6 | 4-6 | 21-24 | 5-10 | | 0-8 | 0-0.35 | |
| CaO | 6-10 | 11-15 | 0-1 | 16-25 | 17-25 | 1-10 | 8-15 | 0-0.2 |
| MgO | 0-4 | 2-4 | | 0-5 | 0-4 | | 4-7 | 9.5-10 |
| ZnO | | | | | 2-5 | | | |
| BaO | | 0-1 | | | | | | |
| Li₂O | | | | | | 0-1.5 | | |
| Na₂O + K₂O | 14-16 | 7-10 | 0-4 | 0-2 | 0-2 | 11-21 | 0-1 | 0-0.2 |
| TiO₂ | 0-0.6 | | | 0-1.5 | 0-4 | 0-12 | | |
| ZrO₂ | | | | | | 1-18 | | |
| Fe₂O₃ | 0-0.5 | 0-0.8 | 0-0.3 | 0-0.8 | 0-0.8 | 0-5 | 0-0.5 | 0-0.1 |
| F₂ | 0-0.4 | | | 0-1 | | 0-5 | 0-0.3 | |

In some implementations, the fibers in CNSF and/or SCNSF are silica glass fibers, ECR, E-glass or S-2, for example.

In an illustrative example, the substrate-containing CNS material is a silica glass fiber (ECR or S-2) coated with 17 weight % conductive CNSs. In another illustrative example, the substrate-containing CNS material has conductive CNSs is an amount of about 2% by weight. In yet another illustrative example, the substrate-containing CNS material can have up to 20 wt % CNSs infused on a glass fiber substrate uniformly. In a further illustrative example, the substrate-containing CNS material presents a patchy coverage of the substrate with about 2 wt % CNSs on the substrate.

Illustrative SEM images are shown in FIGS. 4, 5A and 5B. Specifically, FIG. 4 is a SEM image of a CNSF material, while FIGS. 5A and 5B are SEM images of a SCNSF material at two different magnifications.

The length of the fiber in CNSF or SCNSF can be within a range of from about 1 mm to about 10 mm, such as, for example, within a range of from 1 mm to 2 mm, 1 mm to 3 mm, 1 mm to 4 mm, 1 mm to 5 mm, 1 mm to 6 mm, 1 mm to 7 mm, 1 mm to 8 mm, 1 mm to 9 mm; or from 2 mm to 3 mm, from 2 mm to 4 mm, from 2 mm to 5 mm, from 2 mm to 6 mm, from 2 mm to 7 mm; from 2 mm to 8 mm, from 2 mm to 9 mm, from 2 mm to 10 mm; or from 3 mm to 4 mm, from 3 mm to 5 mm, from 3 mm to 6 mm, from 3 mm to 7 mm, from 3 mm to 8 mm, from 3 mm to 9 mm, from 3 mm to 10 mm; or from 4 mm to 5 mm, from 4 mm to 6 mm, from 4 mm to 7 mm, from 4 mm to 8 mm, from 4 mm to 9 mm, from 4 mm to 10 mm; or from 5 mm to 6 mm, from 5 mm to 7 mm, from 5 mm to 8 mm, from 5 mm to 9 mm, from 5 mm to 10 mm; or from 6 mm to 7 mm, from 6 mm to 8 mm, from 6 mm to 9 mm, from 6 mm to 10 mm; or from 7 mm to 8 mm, from 7 mm to 9 mm, from 7 mm to 10 mm; or from 8 mm to 9 mm, from 8 mm to 10 mm; or from 9 mm to 10 mm.

Typical fiber diameters can be within a range of from about 5 to about 20 microns (μm), for instance within a range of from 5 to 7, from 5 to 9, from 5 to 11, from 5 to 13, from 5 to 15, from 5 to 17, from 5 to 19 μm; or from 7 to 9, from 7 to 11, from 7 to 13, from 7 to 15, from 7 to 17, from 7 to 19 μm; or from 9 to 11, from 9 to 13, from 9 to 15, from 9 to 17, from 9 to 19 μm; or from 11 to 13, from 11 to 15, from 11 to 17, from 11 to 19 μm; or from 13 to 15, from 13 to 17, from 13 to 19 μm; or from 15 to 17, from 15 to 19 μm; or from 17 to 19 μm.

In one implementation, the fibers in CNSF or SCNSF are about 5 mm long. In another implementation the fibers in CNSF or SCNSF are about 2 mm long. A typical fiber diameter for these or for other suitable fiber lengths is within the range of from about 12 to about 15 μm.

Carbon nanostructures free of fibers (CNS), the substrate-containing CNS material, e.g., CNSs fibers or spent CNSs fibers, can be provided as granules, pellets, or in other forms. In a typical manufacturing production, for instance, flakes can be further processed, e.g., by cutting or fluffing (operations that can involve mechanical ball milling, grinding, blending, etc.), chemical processes, blending techniques, or any combination thereof. Resulting CNSs products can include loose particulate material (as CNS flakes, granules, pellets, etc., for example), formulations that may include a liquid medium, e.g., dispersions, slurries, pastes, and so forth. The material can be “wetted”, i.e., treated with or containing one or more suitable compounds (water, other solvents, surfactants, etc.) for improving dispersion and/or mixing properties. In many cases, wetted CNS materials maintain the appearance of dry particulates.

Suitable particulate materials can have a typical particle size within the range of from about 1 mm to about 1 cm, for example, from about 0.5 mm to about 1 mm, from about 1 mm to about 2 mm, from about 2 mm to about 3 mm, from about 3 mm to about 4 mm, from about 4 mm to about 5 mm, from about 5 mm to about 6 mm, from about 6 mm to about 7 mm, from about 7 mm to about 8 mm, from about 8 mm to about 9 mm or from about 9 mm to about 10 mm.

Bulk densities characterizing the materials that can be employed in the compositions, electrodes or batteries described herein can be within the range of from about 0.005 g/cm³ to about 0.1 g/cm³, e.g., from about 0.01 g/cm³ to about 0.05 g/cm³.

In a specific implementation, the CNSF material has a bulk density of 150-210 g/L, e.g., from 150 to 170, from 150 to 190, from 150 to 200; or from 170 to 190, from 170 to 210; or from 190 to 210 g/L. In another specific implementation, the SCNSF has a bulk density within a range of from about 230 to 310 g/L, e.g., from 230 to 250, from 230 to 270 from 230 to 290; or from 250 to 270; from 250 to 290, from 250 to 310; or from 270 to 290, from 270 to 310; or from 290 to 310 g/L. One illustrative CNSF material has a bulk density of 182.7 g/L. An illustrative SCNSF material has a bulk density of 276.8 g/L

In some embodiments, the CNS and/or the substrate-containing material, e.g., CNSF, or SCNSF, is/are “coated”, also described herein as “sized” or “encapsulated”. In a typical sizing process, the coating is applied onto the CNTs that form the CNS. The sizing process can form a partial or a complete coating that is non-covalently bonded to the CNTs and, in some cases, can act as a binder. In addition, or in the alternative, the size can be applied to already formed CNSs in a post-coating (or encapsulation) process. With sizes that have binding properties, CNSs can be formed into larger structures, granules or pellets, for example. In other embodiments the granules or pellets are formed independently of the function of the sizing.

Coating amounts can vary. For instance, relative to the overall weight of coated CNSs devoid of substrate or of a coated substrate-containing CNS material, the coating can be within the range of from about 0.1 weight % to about 10 weight % (e.g., within the range, by weight, of from about 0.1% to about 0.5%; from about 0.5% to about 1%; from about 1% to about 1.5%; from about 1.5% to about 2%; from about 2% to about 2.5%; from about 2.5% to about 3%; from about 3% to about 3.5%; from about 3.5% to about 4%; from about 4% to about 4.5%; from about 4.5% to about 5%; from about 5% to about 5.5%; from about 5.5% to about 6%; from about 6% to about 6.5%; from about 6.5% to about 7%; from about 7% to about 7.5%; from about 7.5% to about 8%; from about 8% to about 8.5%; from about 8.5% to about 9%; from about 9% to about 9.5%; or from about 9.5% to about 10%.

In many cases, controlling the amount of coating (or size) reduces or minimizes undesirable effects on the properties of the CNS material itself. Low coating levels, for instance, are more likely to preserve electrical properties brought about by the incorporation of CNSs or CNS-derived (e.g., CNS fragments of fractured CNTs) materials in the compositions, electrodes and/or batteries described herein.

Various types of coatings can be selected. In many cases, sizing solutions commonly used in coating carbon fibers or glass fibers could also be utilized to coat CNSs. Specific examples of coating materials include but are not limited to fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. In many implementations, the CNSs used are treated with a polyurethane (PU), a thermoplastic polyurethane (TPU), or with polyethylene glycol (PEG).

Polymers such as, for instance, epoxy, polyester, vinylester, polyetherimide, polyetherketoneketone, polyphthalamide, polyetherketone, polyetheretherketone, polyimide, phenol-formaldehyde, bismaleimide, acrylonitrile-butadiene styrene (ABS), polycarbonate, polyethyleneimine, polyurethane, polyvinyl chloride, polystyrene, polyolefins, polypropylenes, polyethylenes, polytetrafluoroethylene, elastomers such as, for example, polyisoprene, polybutadiene, butyl rubber, nitrile rubber, ethylene-vinyl acetate polymers, silicone polymers, and fluorosilicone polymers, combinations thereof, or other polymers or polymeric blends can also be used in some cases. In order to enhance electrical conductivity, conductive polymers such as, for instance, polyanilines, polypyrroles and polythiophenes can also be used.

It is possible that mixing and/or other operations used to prepare the compositions, electrodes or batteries described herein can generate CNS-derived species such as “CNS fragments” and/or “fractured CNTs”. Except for their reduced sizes, CNS fragments (a term that also includes partially fragmented CNSs) generally share the properties of an intact CNS. Fractured CNTs can be formed when crosslinks between CNTs within the CNS are broken, under applied shear, for example. Derived (generated or prepared) from CNSs, fractured CNTs are branched and share common walls with one another.

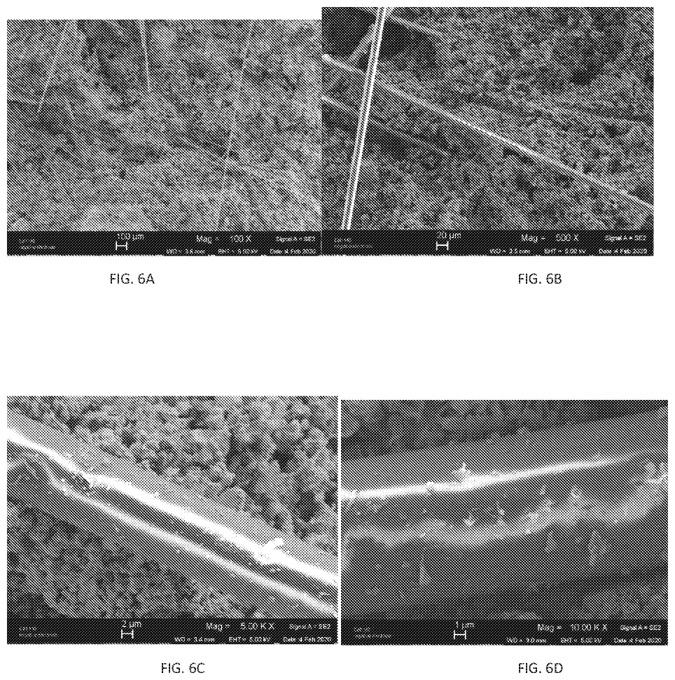

It is possible that operations (mixing, for instance) used to prepare the compositions, electrodes or batteries described herein may result in the separation or detachment of CNSs from the growth substrate (e.g., a fiber material) present in the substrate-containing material, e.g., CNSF or SCNSF. In some cases, it was found that CNSs infused fibers remained intact. Also, an investigation of other areas in the sample did not reveal any CNSs in regions outside CNSF. FIGS. 6A through 6D are SEM images (at different magnifications) of an electrode (after paste mixing and electrode forming operations). The glass surface left has a coating containing Fe, Si, and carbon that is known as a carbon cap layer on Fe catalyst particles, a very beginning stage of CNS growth as shown in the SEM images.

The presence of CNSs, CNS fragments and/or fractured CNSs can be identified and/or characterized by various techniques. Optical microscopy and electron microscopy, including techniques such as transmission electron microscopy (TEM) and scanning electron microscopy (SEM), for example, can provide information about features such as the frequency of specific number of walls present, branching, the absence of catalyst particles, etc. (See, e.g., FIGS. 2A-2D.) Raman spectroscopy can point to bands associated with impurities. For example, a D-band (around 1350 cm⁻¹) is associated with amorphous carbon; a G band (around 1580 cm⁻¹) is associated with crystalline graphite or CNTs). A G′ band (around 2700 cm⁻¹) is expected to occur at about 2× the frequency of the D band. In some cases, it may be possible to discriminate between CNS and CNT structures by thermogravimetric analysis (TGA).

Fibers or other types of growth substrates present in CNSs fibers and/or spent CNSs fibers can be identified and often quantified using SEM or another suitable analytical method. Whether or not CNSs remain attached to the fiber substrate throughout preparative operations can be determined by SEM imaging, for example.

The carbon-based additive employed in practicing the invention often includes more than one type of CNS material. Thus, in some implementations, the carbon-based additive will include a constituent selected from the group consisting of CNS (carbon nanostructures free of substrate), one or more substrate-containing CNS material (s), e.g., CNSF and/or SCNSF) and any combination thereof.

Moreover, in many embodiments of the invention, the carbon-based additive will further include another carbonaceous additive, often a conductive carbon additive, such as, for instance, a carbon black (CB), a blend of CBs, and/or conventional CNTs, i.e., CNTs that are not generated or derived from CNSs, e.g., during processing. Such CNTs can be provided in individualized form, as manufactured commercially, for example. In many cases, the conventional CNTs are MWCNTs, typically containing fair amounts of catalyst and support residuals, species that can be observed by techniques such as SEM, TEM, inductively coupled plasma atomic emission spectroscopy or ICP-AES, etc.

In specific implementations, the CNS component including CNS (carbon nanostructures free of substrate) and/or one or more substrate-containing CNS material(s) e.g., CNSF and/or SCNSF, is/are provided in conjunction with CB.

Carbon blacks can be described by properties determined according to procedures, often standardized protocols, well known in the art. For instance, CBs can be characterized by their Brunauer-Emmett-Teller (BET) surface area, measured, for example, according to ASTM D6556-10; by their oil adsorption number (OAN), determined, for instance, according to ASTM D 2414-16; by their statistical thickness surface areas (STSAs), a property that can be determined by ASTM D 6556-10.

For a given CB, it may also be of interest, in some cases, to specify the ratio of its STSA to its BET surface area (STSA:BET ratio).

Crystalline domains can be characterized by an Lₐ crystallite size, as determined by Raman spectroscopy. La is defined as 43.5×(area of G band/area of D band). The crystallite size can give an indication of the degree of graphitization, where a higher La value correlates with a higher degree of graphitization. Raman measurements of La were based on Gruber et al., “Raman studies of heat-treated carbon blacks,” Carbon Vol. 32 (7), pp. 1377-1382, 1994, which is incorporated herein by reference. The Raman spectrum of carbon includes two major “resonance” bands at about 1340 cm⁻¹ and 1580 cm⁻¹, denoted as the “D” and “G” bands, respectively. It is generally considered that the D band is attributed to disordered sp² carbon, and the G band to graphitic or “ordered’ sp² carbon. Using an empirical approach, the ratio of the G/D bands and an La measured by X-ray diffraction (XRD) are highly correlated, and regression analysis gives the empirical relationship:

Lₐ=43.5×(area of G band/area of D band),

in which La is calculated in Angstroms. Thus, a higher La value corresponds to a more ordered crystalline structure.

The crystalline domains can be characterized by a L_{c} crystallite size. The L_{c} crystallite size was determined by X-ray diffraction using an X-ray diffractometer (PANalytical X'Pert Pro, PANalytical B.V.), with a copper tube, tube voltage of 45 kV, and a tube current of 40 mA. A sample of carbon black particles was packed into a sample holder (an accessory of the diffractometer), and measurement was performed over angle (2θ) range of 10° to 80°, at a speed of 0.14°/min. Peak positions and full width at half maximum values were calculated by means of the software of the diffractometer. For measuring-angle calibration, lanthanum hexaboride (LaB₆) was used as an X-ray standard. From the measurements obtained, the L_{c} crystallite size was determined using the Scherrer equation: L_{c} (Å)=K*λ/β*cosθ), where K is the shape factor constant (0.9); λ is the wavelength of the characteristic X-ray line of Cu K_{α1} (1.54056 Å); β is the peak width at half maximum in radians; and θ is determined by taking half of the measuring angle peak position (2θ).

The BET of the CB employed can be within the range of from about 40 to about 2000, e.g., from about 1300 to about 1600, such as, for instance, within the range of from 1300 to 1350; from 1300 to 1400, from 1300 to 1450, from 1300 to 1500, from 1300 to 1550; or from 1400 to 1450, from 1400 to 1500, from 1400 to 1550, from 1400 to 1600; or from 1500 to 1550, from 1500 to 1600 m²/g. Compositions described herein can contain CB characterized by different BET values.

The OAN of the CB employed can be within the range of from about 100 to about 400, e.g., from about 130 to about 250 ml/100 g, such as, for example, within a range of from about 130 to 150, from 130 to 170, from 130 to 190, from 130 to 210, from 130 to 230, from 130 to 250; or from 150 to 170, from 150 to 190, from 150 to 210, from 150 to 230, from 150 to 250; or from 170 to 190, from 170 to 210, from 170 to 230, from 170 to 250; or from 190 to 210, from 190 to 230, from 190 to 250; or from 210 to 230, from 210 to 250; or from 230 to 250 ml/100 g.

The STSA of the CB employed can be within the range of from about 40 to about 800, e.g., from about 500 to about 600 m²/g. In specific embodiments, the STSA is within a range of from 500 to 520, from 500 to 540, from 500 to 560, from 500 to 580; or from 520 to 540, from 520 to 560, from 520 to 580, from 520 to 600; or from 540 to 560, from 540 to 580, from 540 to 600; or from 560 to 580, from 560 to 600; or from 580 to 600 m²/g.

For the purpose of this application, the STSA:BET ratio for the CB particles used can be within the range of about 0.2 to about 1, for instance within a range of from 0.2 to 0.4, from 0.2 to 0.6, from 0.2 to 0.8; or from 0.4 to 0.6, from 0.4 to 0.8, from 0.4 to 1; or from 0.6 to 0.8, from 0.6 to 1; or from 0.8 to 1.

Exemplary CBs that could be utilized are described, for instance, in U.S. Pat. Nos. 9,053,871, 8,932,482, 9,112,231, 9,281,520, 9,287,565, 9,985,281, 9,923,205, U.S. Patent Application Publication No. 20140093775A1 and International Patent Application No. PCT/US2019/063209, published as WO 2020/117555. These documents, in their entirety, are incorporated herein by this reference.

In one illustrative example, the CB has: a) a nitrogen BET surface area (BET) of from 650 m.sup.2/g to 2050 m²/g; b) a dibutyl phthalate adsorption value for the carbon black determined after controlled compression (CDBP valued in mL/100 g of from about (−2.8+(b*BET)) to about (108+(b*BET)), where b is 0.087 and BET is expressed in m²/g; and c) an apparent density (ρ, g/cm3) of at least about 0.820+q*BET, where q=−2.5×10⁻⁴, as determined at a compressive force (P) of 200 kgf/cm² on dry carbon black powder.

In another illustrative example, the CB is an oxidized CB characterized by: a BET surface area ranging from 650 to 2100 m.sup.2/g; an oil absorption number (OAN) ranging from 35 to 500 mL/100 g; and at least one of the following properties: (a) a volatile content of at least 5.5 wt. % relative to the total weight of the oxidized carbon black, as determined by weight loss at 950.degree. C.; (b) a total oxygen content of at least 3.5 wt. % relative to the total weight of the oxidized carbon black; (c) a total titratable acidic group content of at least 0.5 μmol/m², as determined by Boehm's titration method; and (d) a total titratable acidic group content of at least 0.5 mmol/g, as determined by Boehm's titration method.

In a further illustrative examples, the CB has a Bnmauer-Emmett-Teller (BET) surface area greater than or equal to 90 m²/g and less than or equal to 900 m²/g, and an oil adsorption number (OAN) greater than or equal to 150 mL/100 g and less than or equal to 300 mL/100 g.

In yet another illustrative example, the CB has: (a) a BET surface area between about 600 and about 2100 m.sup.2/g; and (b) an oil adsorption number (OAN) in the range of about 35 to about 360 cc/100 g, provided that the oil absorption number is less than 0.14× the BET surface area+65.

In another illustrative example, the CB has a BET surface area ranging from 100 m²/g to 1100 m²/g, and a surface energy (SE) of 10 mJ/m² or less, and a Raman microcrystalline planar size (La) of at least 22 Angstroms, e.g., ranging from 22 Angstroms to 50 Angstroms. In some cases, the CB also has a statistical thickness surface area (STSA) of at least 100 m²/g, e.g., ranging from 100 m²/g to 600 m²/g.

In a further illustrative example, the CB has a surface area ranging from 400 m²/g to 1800 m²/g and/or a DBP ranging from 32 mL/100 g to 500 mL/100 g.

In many cases, the CB particles are commercially available. Examples include but are not limited to PBX®09, PBX®140, PBX®135, VulcanXC®72, PBX®51, Vulcan®XCmax™, CSX®946, CSX®960 carbon black particles, available from Cabot Corporation. Other carbon blacks such as those under the name of Denka® Black from Denka Company Limited or PRINTEX® Kappa 210, 220, 240 from ORION Engineering Carbons also can be employed. Specific examples of carbon-based additives utilize a combination of CNSs, CNSF and/or SCNSF with PBX®09 or PBX®51 carbon black particles.

Some embodiments of the invention employ more than one type of CB particles, e.g., in a blend. In one illustration the carbon-based additive will contain at least two carbon blacks having STSAs that are different form one another. Also possible are blends of carbon blacks with structure-OAN that are different from each other and/or blends of different carbon morphology, i.e. activated carbon or graphite with carbon black.

Carbon nanostructures free of substrate and/or the substrate-containing CNS material (e.g., CNSF and/or SCNSF) also can be used in conjunction with other carbonaceous additives, such as, for instance, conventional CNTs, i.e., CNTs that are not generated or derived from CNSs, e.g., during processing. Such CNTs can be provided in individualized form, as manufactured commercially, for example. In many cases, the conventional CNTs are MWCNTs typically containing fair amounts of catalyst and support residuals, as determined, for instance, by techniques such as ICP-AES.

Some exemplary CNTs are illustrated by specification I-III in Table 2, below.

TABLE 2

| | BET | | OAN, | Lₐ | (I_{G}/(I_{G} + | L_{c} |
|---|---|---|---|---|---|---|
| CB | SA, | STSA, | mL/ | Raman | I_{D})) % Cr, | XRD |
| Specification | m²/g | *m²/g | 100 g | Å | Raman | Å |
| I | 230 | N/A | N/A | 52.5 | 55 | 45 |
| II | 170 | N/A | N/A | 30 | 40 | 41 |
| III | 191 | N/A | N/A | 56 | 55 | 31 |

Values presented in Table 2 are typically determined using the techniques described above with respect to CB.

Constituents making up the carbon-based additive can be provided in any desired ratio. For instance, a carbon-based additive can contain CNS (carbon nanostructures free of substrate) and CB in a CNS:CB ratio within a range of from about 0.1 to about 5, e.g., from 0.5 to 1, from 0.5 to 2, from 0.5 to 3, from 0.5 to 4, from 0.5 to 5; or from 1 to 2, from 1 to 3, from 1 to 4, from 1 to 5; or from 2 to 3, from 2 to 4, from 2 to 5; or from 3 to 4, from 3 to 5; or from 4 to 5.

Another carbon-based additive can contain CNSF and CB in a CNSF: CB ratio within a range of from about 0.1 to about 5, e.g., from 0.5 to 1, from 0.5 to 2, from 0.5 to 3, from 0.5 to 4, from 0.5 to 5; or from 1 to 2, from 1 to 3, from 1 to 4, from 1 to 5; or from 2 to 3, from 2 to 4, from 2 to 5; or from 3 to 4, from 3 to 5; or from 4 to 5.

Yet another carbon-based additive can contain SCNSF and CB in a SCNSF: CB ratio within a range of from about 0.1 to about 5, e.g., from 0.5 to 1, from 0.5 to 2, from 0.5 to 3, from 0.5 to 4, from 0.5 to 5; or from 1 to 2, from 1 to 3, from 1 to 4, from 1 to 5; or from 2 to 3, from 2 to 4, from 2 to 5; or from 3 to 4, from 3 to 5; or from 4 to 5.

CNS and CNSF can be combined in a CNS: CNSF ratio within a range of from about 0.1 to about 5, e.g., from 0.5 to 1, from 0.5 to 2, from 0.5 to 3, from 0.5 to 4, from 0.5 to 5; or from 1 to 2, from 1 to 3, from 1 to 4, from 1 to 5; or from 2 to 3, from 2 to 4, from 2 to 5; or from 3 to 4, from 3 to 5; or from 4 to 5.

CNS and SCNSF can be combined in a CNS: SCNSF ratio within a range of from about 0.1 to about 5, e.g., from 0.5 to 1, from 0.5 to 2, from 0.5 to 3, from 0.5 to 4, from 0.5 to 5; or from 1 to 2, from 1 to 3, from 1 to 4, from 1 to 5; or from 2 to 3, from 2 to 4, from 2 to 5; or from 3 to 4, from 3 to 5; or from 4 to 5.

CNSF and SCNSF can be combined in a CNSF: SCNSF ratio of from about 0.1 to about 10, e.g., from 0.5 to 2, from 0.5 to 4, from 0.5 to 6, from 0.4 to 8, from 0.5 to 10; or from 1 to 2, from 1 to 4, from 1 to 6, from 1 to 8, from 1 to 10; or from 2 to 4, from 2 to 6, from 2 to 8, from 2 to 10; or from 4 to 6, from 4 to 8, from 4 to 10; or from 6 to 8, from 6 to 10; or from 8 to 10.

The illustrative ratios provided above can be adjusted to accommodate one or more additional constituents, for instance, by maintaining a desired loading for the entire carbon-based additive. In one example, the carbon-based additive contains CB in an amount of from about 0.1 to about 1.5% by weight; CNS in an amount of from about 0.1 to about 1.5%; and CNSF or SCNSF in an amount of from about 0.05% to about 0.5% by weight.

Additional materials, such as, for instance, glass fibers (without CNSs), carbon fibers, e.g., carbon nanofibers, activated carbon, graphitic carbon, graphene, silica, silicate, silicate fibers can be utilized in conjunction with the CNSs (devoid of substrate) and/or substrate-containing CNS materials (e.g., CNSF and/or SCNSF), optional CB and/or optional CNTs.

Embodiments of the invention use a carbon-based additive that includes, for instance, CNS (carbon nanostructures free of substrate), a substrate-containing CNS material (e.g., CNSF and/or SCNSF), any combination thereof, or any combination of CNS, a substrate containing material (e.g., CNSF and/or SCNSF) with CB and/or CNTs, to prepare an electrode composition.

On a dry basis, the loading of the carbon-based additive (composed, for example, of one or more of CNSs (free of substrate), substrate-containing CNS material (e.g., CNSF and/or SCNSF), with or without CB and/or CNTs) in the electrode composition can be 3 weight % or below, often less than or equal to 2.5, 2, 1.5, 1, 0.5 or even less, e.g., less than or equal to 0.45, 0.4, 0.35, 0.3, 0.25, 0.2, 0.15 or 0.1 weight %. With respect to ranges, these materials can be present in an amount within a range of from about 0.1 to about 0.5, from about 0.1 to about 1, from about 0.1 to about 1.5, from 0.1 to about 2., from about 0.1 to about 2.5, from about 0.1 to about 3; or from about 0.5 to about 1, from 0.5 to about 1.5, from about 0.5 to about 2, from about 0.5 to about 2.5, from about 0.5 to about 3; or from about 1 to about 1.5, from about 1 to about 2, from about 1 to about 2.5, from about 1 to about 3; or from about 1.5 to about 2, from about 1.5 to about 2.5, from about 1.5 to about 3; or from about 2 to about 2.5, from about 2 to about 3; or from about 2.5 to about 3. Values in between or outside these specific ranges also can be selected.

It is possible, in some cases, that at higher loadings of CNSF (or SCNSF), e.g., loading higher than 0.5 weight %, and fiber lengths of 5 mm, fiber entanglements may negatively affect electrode uniformity. In one example, the CNSF and/or SCNSF loading is within a range of from 0.25 to 0.20, from 0.25 to 0.15, from 0.25 to 0.10, from 0.25 to 0.05, from 0.25 to 0.01 weight %.

For lead acid batteries, the composition, often a paste, will also contain negative active materials (NAM).

In many embodiments, the NAM include a lead-containing material, such as, for instance, Pb, PbO, Pb₃O₄, 3PbO·PbSO₄ (3BS), 4PbO·PbSO₄(4BS), PbSO₄, hydroxides thereof, acids thereof, and/or other polymetallic lead complexes. A source of the lead-containing material can be a composition known as “leady oxide”, which comprises primarily PbO and Pb. In one illustrative leady oxide, Pb is present in an amount of 20% by weight, while PbO is present in an amount of 80% by weight. More generally, Pb can be present in a leady oxide in an amount within the range of from about 1 to about 50 weight %, while PbO can be present in the leady oxide in an amount within the range of from about 50 to about 100%.

The lead oxide can include red tetragonal lead oxide (tet-PbO) (also known as α-PbO or litharge) and yellow orthorhombic lead oxide (orthorhomb-PbO) (also known as β-PbO or massicot). One illustrative example includes 80 weight % α-PbO and 20 weight % β-PbO. More generally, leady oxides can employ α-PbO in an amount within the range of from about 65 to about 95% by weight; and β-PbO in an amount of from about 5 to about 35% by weight.

Leady oxide can be provided in a suitable particle size, such as for example, a particle size within the range of from about 0.5 to about 10 microns, e.g., within the range of from about 2 to about 8, such as within the range of from about 3 to about 5 microns (μm). In many cases, leady oxide, in various specifications, is commercially available.

Typically, the negative electrode composition will also include an organic molecule expander, a term which refers to a molecule capable of adsorbing or covalently bonding to the surface of a lead-containing species to form a porous network that prevents or substantially decreases the rate of formation of a smooth layer of PbSO₄ at the surface of the lead-containing species. In one embodiment, the organic molecule expander has a molecular weight greater than 300 g/mol. Exemplary organic molecule expanders include lignosulfonates, lignins, wood flour, pulp, humic acid, and wood products, and derivatives or decomposition products thereof. In specific implementations, the expander is a lignosulfonate, with a substantial portion of its containing a lignin structure. Lignins are polymeric species comprising primarily phenyl propane groups with some number of methoxy, phenolic, sulfur (organic and inorganic), and carboxylic acid groups. Typically, lignosulfonates are lignin molecules that have been sulfonated. Examples of lignosulfonates include products under the names of UP-393, UP-413, UP-414, UP-416, UP-417, M, D, VS-A (Vanisperse A), VS-HT, VS-DCA (Vanisperse DCA) from Borregaard Lignotech. Other useful exemplary lignosulfonates are listed in, “Lead Acid Batteries”, Pavlov, Elsevier Publishing, 2011, the disclosure of which is incorporated herein by reference.

The organic molecule expander can be present in the electrode composition in an amount ranging from 0.1% to 1.5% by weight relative to the total weight of the composition, e.g., from 0.2% to 1.5% by weight, from 0.2% to 1% by weight, from 0.3% to 1.5% by weight, from 0.3% to 1% by weight, or from 0.3% to 0.8% by weight.

Another constituent of the electrode composition includes a metal ion, such as, for instance, calcium, barium, potassium, magnesium, or strontium ion. A compound frequently used is barium sulfate (representing both blanc fixe and barytes forms of this compound and mixtures thereof). Barium sulfate (BaSO₄) can be provided in particle sizes from 0.1 to 5 micrometers and acts as a nucleating agent for lead sulfate produced when the plate is discharged. In more detail, it is believed that the lead sulfate discharge product deposits on the barium sulfate particles assuring homogeneous distribution throughout the active material and preventing coating of the lead particles. The term barium sulfate represents both blanc fixe and barytes forms of this compound and mixtures thereof. It is desirable that the barium sulfate crystals have a very small particle size, of the order of 1 micron or less, so that a very large number of small seed crystals are implanted in the negative active material. This ensures that the lead sulfate crystals, which are growing on the barium sulfate nuclei, are small and of a uniform size so that they are easily converted to lead active material when the plate is charged.

In many implementations, the barium to carbon (Ba:C) weigh ratio in the formulation is from 0.1 to 6. In more detail, the metal ion (barium ion, for instance) amount is present in a ratio of 0.1-6 relative to the total weight of carbon-based additive (e.g., including CNSs, CNSF, SCNSF, optional CB and/or CNTS, etc.).

The weight ratio of the carbon-based additive (including, for example, CNSs, a substrate-containing CNS material (e.g., CNSF and/or SCNSF) or any combination thereof, optionally further including CB and/or CNTs) to leady oxide can be within a range of from about be from about 20:80 to about 0.5:99.5, such as from about 5:95 to about 1:99.

The weight ratio of the carbon-based additive to barium sulfate can be from about 90:10 to about 20:80, such as from about 80:20 to about 30:70.

The weight ratio of carbon-based additive to lignosulfonate can be from about 90:10 to about 40:60, such as from about 80:20 to about 60:40.

Typically, the composition will also include sulfuric acid and water. The H₂SO₄ can have a density ranging from 1.05 g/cm³ to 1.5 g/cm³. H₂SO₄ having a specific gravity (sp) within the range of from 1.0 to 1.5, also can be employed.

Components can be mixed in any convenient order, using suitable mixing equipment and mixing parameters (temperature, time, energy, etc.).

For instance, the “carbon-based” or “carbonaceous” additive (also referred to herein as material, component or constituent) and including at least one of CNSs, a substrate-containing CNS material (e.g., CNSF and/or SCNSF), often in the presence of CB and/or CNTs, can be combined with the lead-containing material, expander, and optionally other components, e.g., BaSO₄ and H₂SO₄.

Combinations of two or more ingredients (e.g., CNS, CNSF, SCNSF, CB, CNTs) can be provided by adding them individually (sequentially, in any order, or simultaneously) or as a preformed blend. The lead-containing material, expander, and BaSO₄ can be combined and provided as a dry mixture. Sulfuric acid and/or water can be combined with this dry mixture simultaneously or sequentially (in any order).

In some cases, the lead-containing material, an organic molecule expander, BaSO₄, and sulfuric acid and/or water (added either simultaneously or sequentially in any order) are combined into a slurry. The slurry is then combined with the carbonaceous material.

In some implementations, the carbon-based additive (or constituents thereof) is/are prewetted with water and/or sulfuric acid prior to combining with other ingredients. One skilled in the art can determine the amount of water or acid needed for prewetting, based, e.g., on the amount of carbonaceous material added. In one embodiment, for a water-prewetted material, the ratio of carbon-based additive to water ranges from 1:1 to 1:3 by weight. The prewetting step can be performed according to any method known in the art, e.g., by adding the water dropwise to the carbonaceous constituent or adding the carbon-based constituent (e.g., slowly) to a volume of water.

In other implementations, the carbon-based additive comprises water. In one embodiment, this material is a “wet” powder in which the water is contained or primarily contained in the pores of the carbonaceous material. The wet powder behaves more like a powder as opposed to a dispersion or slurry. In certain cases, the wet powder is more easily dispersible compared to a dry powder. The presence of water in the pores of the carbonaceous material allows elimination of a prewetting step, and the carbonaceous material can be incorporated into the electrode composition as is.

The prewetted or the wet powder can be directly combined with a lead-containing material, organic molecule expander, and other components such as BaSO₄ and H₂SO₄ to form the electrode composition. In some cases, the wet powder can be stored under conditions to preserve the water content and later combined with the lead-containing material, organic molecule expander and optionally other components to form the electrode composition.

Once the ingredients are combined (e.g., by blending or mixing, using equipment known in the art, e.g., planetary mixer with or without milling media), the electrode composition, e.g., paste, can be evaluated for various characteristics, such as, for instance, moisture content (MC), density, penetration and others. Properties of interest in an electrode paste often pertain to the ability of the paste to stick to a substrate, typically a metal grid. Methods for measuring these properties are well established; some are described in the working examples below. Desired values are known in the art, can be determined by routine experimentation or estimated, based on experience, for instance.

The phase composition of the paste can depend on the H₂SO₄/LO ratio (LO being the oxidized lead powder), temperature, additives and time of mixing. The paste often represents a non-equilibrium system including crystalline basic lead sulfates and oxides, and amorphous sulfate-containing components.

In one illustration, at temperatures below 60° C., the ratio of H₂SO₄ to LO can be up to 12%, and the paste could contain tribasic lead sulfate (3PbO·PbSO₄·H₂O or “3BS”)+tet-PbO+orthorhombic-PbO+Pb. A maximum content of 3BS often can be obtained at 10% H₂SO₄/LO.

At temperatures above 70° C., the H₂SO₄/LO ratio can be up to 7%. The paste typically contains tetrabasic lead sulfate (4 PbO·PbSO₄ or “4BS”)+tet-PbO+orthorhombic-PbO+Pb. Maximum content of 4BS can be obtained at 6.5% H₂SO₄/LO.

During the course of mixing 3BS and orthorhombic-PbO tend to form first. Then 4BS is formed by the reaction of 3BS+tet-PbO+orthorhombic-PbO. 4BS nucleation is the slowest process and depends strongly on temperature. (In the presence of surface active additive(s) (expander(s)), 4BS and orthorhombic-PbO may not form at all.)

To prepare a lead acid battery or electrode thereof, the composition (typically pertaining to the negative plate) is applied to a substrate, e.g., a metal plate of grid, often made of a lead alloy. The application can be to a desired loading and/or thickness and the coated grid can be evaluated with respect to its weight, thickness and/or other parameters of interest in the manufacture of lead acid batteries.

The coated grid is cured e.g., in an oven, typically under controlled temperature and humidity conditions. This operation is conducted over a suitable time interval and involves drying, crystallization and/or densification of lead components, e.g., PbO, 3BS, 4BS.

In the formation operation, the cured structure becomes part of a battery cell, with the 3BS/4BS phases converting to PbSO₄ and Pb, then to Pb only. Voltage, current and time, are some of the parameters controlled during formation. At this stage, the resulting electrode will be mainly composed of porous lead.

The electrodes can be characterized by their pore volume, pore size distribution, conductivity, X-ray diffraction (XRD) measurements, SEM imaging, etc. In one illustrative example, an electrode according to embodiments described herein will contain porous Pb with a medium pore size of 0.1 to 10 μm and a pore volume of 20-70%, e.g., 20-60%, 20-50%, 20-40%, 20-30%, or 30-70, 30-60, 30-50, 30-50, 30-40; or 40-70, 40-60, 40-50; or 50-70, 50-60 or 60-70.

In some cases, the carbon-based additive reduces the size of Pb crystallites in the NAM cured and formed paste. In some examples, the Pb crystallite has a particle size of 0.1 to 3 μm, e.g., from 0.1 to 0.5, 0.1 to 1, 0.5 to 1.5, 0.5 to 2, 0.1 to 2.5, 0.1 to 3; or from 0.5 to 1, 0.5 to 1.5, 0.5 to 2, 0.5 to 2.5, 0.5 to 3; or from 1 to 1.5, 1 to 2, 1 to 2.5, 1 to 3; or from 1.5 to 2, 1.5 to 2.5, 1.5 to 3; or from 2 to 2.5, 2 to 3; or from 2.5 to 3.

The compositions and/or electrodes described herein can be used in conjunction with a positive plate (electrode) in which a current collector (i.e., a metal plate or grid) is covered with a layer of positive, electrically conductive lead dioxide (PbO₂). Common designs include an absorbed glass mat (AGM) separator, or porous polyethylene separator.

In many embodiments, the battery design, fabrication method and/or equipment employed are as known in the art or as developed in the future. Adding ingredients such as CNSs, CNSF, SCNSF, optionally in combination with CB and/or CNTs, can be carried out within the framework of existing manufacturing processes, relying, for instance, on operational protocols developed for CB addition.

Lead acid batteries employing compositions and electrodes described above can be characterized with respect to various properties (e.g., electrochemical impedance spectroscopy, charging/discharging behavior, cycle life, or other performance characteristics) using a flooded cell design. A testing device can include single 2V cells, 2 negatives, 3 positives (2n-3p), with a nominal capacity of 4.8 Ah, wrapped positives with ribs facing positives and compressed electrodes. A typical electrolyte is sulfuric acid, e.g., 37 weight % (specific gravity (sg) of 1.28 H₂SO₄ (at a fully charged condition). On a dry paste basis, additives for the NAM paste in such a testing device include, for instance: BaSO₄ in an amount of about weight 0.8%; a lignosulfonate type compound at a loading of about 0.2 weight %; and CNSs, CNSF and/or SCNSF, often in combination with CB and/or CNTs.

In some cases, the performance (e.g., using a device or cell such as described above) of a battery according to embodiments described herein can be evaluated relative to a “comparative” battery (device) prepared in the same manner and using the same ingredients except for replacing the carbon-based additive with a conventional additive, CB, for example. In some cases, a battery according to embodiments disclosed herein will require lesser amounts of lead and/or carbon-based additive relative to a comparative battery.

Cell testing can be conducted according to procedures set forth in industry standards or other recognized protocols.

In one example, the dynamic charge acceptance (DCA) testing is conducted according to the EN50342-6:2015 Sec. 7.3 test protocol which includes three different testing segments: Ic, Id and Ir to evaluate negative plate performances in the battery. This European Standard is applicable to lead-acid batteries with a nominal voltage of 12V, used primarily as power source for the starting, lighting and ignition (SLI) as well as auxiliary equipment of internal combustion engine (ICE) vehicles. In addition, batteries under the scope of this standard are used for micro-cycle applications in vehicles which can be called Start-Stop (or ISS (idling-stop system), micro-hybrid or idle stop and go) applications. The standard specifications can be scaled down, for example, to the nominal voltage of a testing device of 2V, such as the one described above.

The EN50342-6:2015 standard sets forth three consecutive parts: pre-cycling, charge acceptance test qDCA delivering Ic and Id; and DCRss micro cycling part delivering Ir.

The reported EN DCA or Inca is calculated by the following formula:

EN I_{DCA}=0.512I_{c}+0.223I_{d}+0.218Iᵣ−0.181

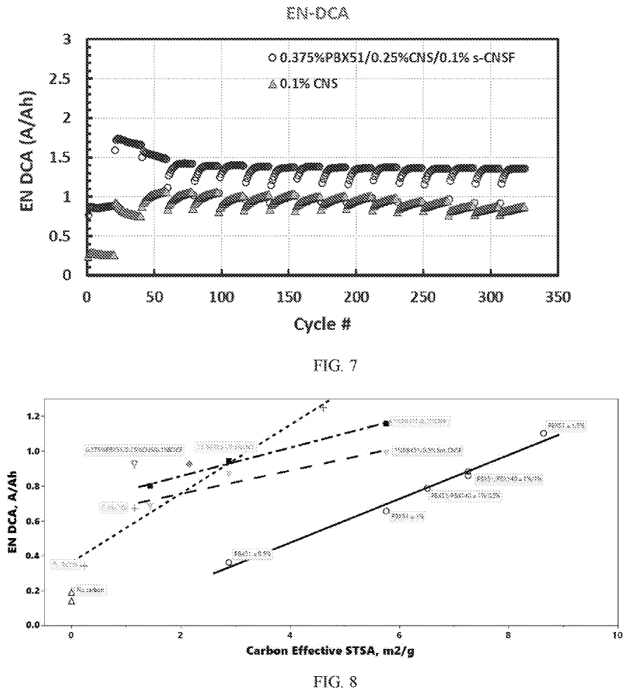

An illustration of Test Standard: EN50342 6:2015, Section 7.3 is presented in FIG. 7, showing the EN DCA (A/Ah) versus cycle number at three different parts: Ic, Id, and Ir.

Lead acid batteries according to embodiments described herein can have a dynamic charge acceptance within a range of from about 0.5 to about 2.6 A/Ah, as measured by EN50342-6:2015. Using this protocol, exemplary lead acid batteries can have a dynamic charge acceptance within a range of from 0.5 to 1, from 0.5 to 1.5, from 0.5 to 2, from 0.5 to 2.3, from 0.5 to 2.5; or from 1 to 1.5, from 1 to 2, from 1 to 2.3 or from 1 to 2.6; or from 2 to 2.3, from 2 to 2.6; or from 2.3 to 2.6 A/Ah. In specific implementations, the lead acid battery has a DCA of at least 0.5 A/Ah, e.g., within a range of from about 0.5 to 1.5, such as, within a range of from about 0.5 to about 0.7, from about 0.5 to 0.9, from 0.5 to 0.9, from 0.5 to 1.1, from 0.5 to 1.3; or from 0.7 to 0.9, from 0.7 to 1.1, from 0.7 to 1.3, from 0.7 to 1.5; or from 0.9 to 1.1, from 0.9 to 1.3, from 0.9 to 1.5; or from 1.1 to 1.3, from 1.1 to 1.5; or from 1.3 to 1.5.

DCA values for illustrative testing devices (cells) at various loadings of carbon-based additives are presented in Table 3 below. Specifically, the table compares DCA values for a testing cell that utilized a carbon-based additive represented by CNSs and various blends. The CB was PBX®51carbon black from Cabot Corporation (abbreviated in this and other tables as “PBX51”).

TABLE 3

| Formulation | EN DCA (A/Ah) |
|---|---|
| CNSs (0.1%) | 0.34 |
| CNSs (0.5%) | 0.67 |
| PBX51/CNSs/Spt. CNSF | 0.86 |
| (0.375%/0.125%/0.25%) | |
| PBX51/CNSs/Spt. CNSF | 0.93 |
| (0.375%/0.25%/0.1%) | |
| PBX51/CNSs/Spt. CNSF | 0.92 |
| (0.5%/0.075%/0.425%) | |
| 0.25% Spent CNSF + 0.25% CNS | 0.59 |
| 0.25% Spent CNSF + 0.5% CNS | 0.92 |

An important attribute characterizing lead acid batteries and electrodes thereof is lead utilization, typically measured by the C/20 discharge capacity. A 1C rate refers to the charge/discharge of the cell capacity in one hour; the C/20 rate is the rate of the charge/discharge cell capacity over 20 hours.

A lead utilization test can be conducted as follows. After the formation of a testing cell, the cell is subjected to a pre-cycling procedure. The procedure includes two complete discharge/charge cycles followed by a C/20 discharge cycle as listed in EN50342-6:2015 Table 10. The lead utilization (Ah/Kg) is calculated based on discharge capacity (Ah) divided by the NAM weight in kilograms (kg).

Based on a procedure such as described above, lead acid batteries according to embodiments described herein can be characterized by a lead utilization within a range of from about 150 to about 200 Ah/kg, e.g., within a range of from 150 to 160, from 150 to 170, from 150 to 180, from 15 to 190; or from 160 to 170, from 160 to 180, from 160 to 190, from 160 to 200; or from 170 to 180, from 170 to 190, from 170 to 200; or from 180 to 190, from 180 to 200; or from 190 to 200 Ah/kg.

Improvements in DCA often can be accompanied by increased water loss. It is expected that batteries according to embodiments of the invention can achieve a water loss that is less than 3 g/Ah, a widely accepted industry standard.

In some embodiments of the invention, the electrode paste is prepared by combining more than one type of CB particles. Blends of different types of CBs can be particularly useful in cases in which adding second type of CB particles can facilitate dispersibility or improve paste rheology. For example, at high loadings, PBX®51 carbon black, particles (from Cabot Corp.) can prove difficult to disperse, potentially leading to high water losses. To improve CB dispersibility and STSA management, a lower BET CB can be added, resulting in enhanced DCA and improved paste rheology. In a specific example, PBX®51 carbon black particles are used in conjunction with PBX®140 carbon black particles. DCA values for different formulations containing PBX51 CB particles are shown in Table 4:

TABLE 4

| Formulation | EN DCA (A/Ah) |
|---|---|
| 1% PBX51 | 0.66 |
| 1% PBX51 + 0.5% PBX140 | 0.79 |
| 1% PBX51 + 1% PBX140 | 0.88 |

A useful parameter for evaluating the effects of carbon-based additives on battery performance is the “effective STSA”, measured in units of m²/g and defined as the loading % of the carbonaceous species (e.g., CB, CNS, CNSF, SCNSF) multiplied by the STSA of the carbonaceous species. To illustrate, in CNSF/CB blend, CNSF does not appear to make a major contribution to STSA. For example, the STSA for CNS pellets can be about 230 m²/g and as a result, CNSF would only contribute 0.5%×17%×230=0.1955 m²/g. Thus, CB would be the main component for an increase in STSA. Fibers, however, can provide additional benefits, i.e. porosity and/or conductivity, relative to an electrode made using only CB.

In some embodiments the effective STSA is within a range of from about 0.1 to about 8, e.g., from 0.1 to 5. In illustrative examples the effective STSA is within a range of from about 0.5 to about 5, e.g., from 0.5 to 1, from 0.5 to 2, from 0.5 to 3, from 0.5 to 4; or from 1 to 2, from 1 to 3, from 1 to 4, from 1 to 5; or from 2 to 3, from 2 to 4, from 2 to 5; or from 3 to 4, from 3 to 5; or from 4 to 5 m²/g.

Advantages associated with using CNS, CNSFs and/or SCNSF in combination with CB are presented in Table 5, which shows a comparison of DCA values for CNSF by itself, CB (PBX®51 carbon black form Cabot Corp) and a blend of the two. (The loadings are relative to PbO.)

TABLE 5

| # | Formulation | EN DCA (A/Ah) |
|---|---|---|
| 1 | 0.5% CNSF | 0.44 |
| 2 | 0.5% PBX51_comparative | 0.36 |
| 3 | 0.5% PBX51 + 0.5% CNSF | 0.94 |

FIG. 8 illustrates the DCA as a function of effective STSA for various carbon-based additives according to embodiments of the invention. As seen in this figure, high effective STSA in NAM (loading, %×STSA, m²/g) leads to increased DCA in all formulations. Both CNSF (green) and SCNSF (red) show a step change increase in DCA vs. CB only formulations. Low STSA CNS significantly improves DCA at low loading 0.5%. CB/CNS/SCNSF blends (blue) can be useful in lowering effective STSA (associated with water loss reduction), and water loss.

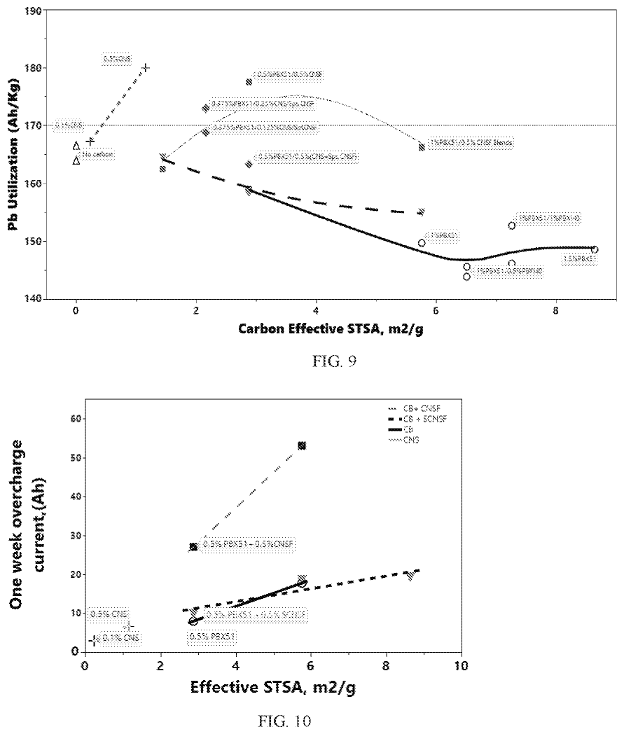

The lead utilization performance for various carbon-based additives as a function of effective STSA is illustrated in FIG. 9. High lead utilization is essential to reduce both PbO and carbon use in NAM, an important consideration in controlling manufacturing costs. Pb utilization for CNSs-containing formulations is about 10% more than that for CB formulations (about 145 to about 165 Ah/kg). Improvements in lead utilization can reduce the amounts of leady oxide required and, as a result, also the amounts of carbon additives needed in the formulation. For comparison purposes, lead utilization for CB can be 160, while using CNS or CNSF (at an appropriate concentration) could improve this parameter to 180 Ah/kg.

FIG. 10 illustrates the water loss performance of various carbon-based additives. The plots present the capacity by integrating one-week overcharge current (Ah) as a function of effective STSA. The data show that CB blends with SCNSF do not increase water loss, while those blends with CNSF appear to negatively impact water loss performance. A CB/CNS/SCNSF blend (blue) is expected to have a similar or lower water loss than control (0.5% PBX®51).

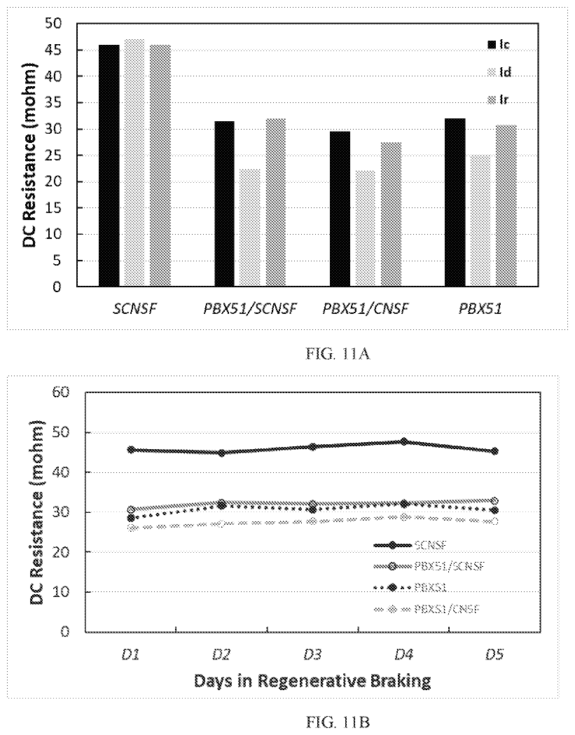

Several formulations were used to evaluate the DC resistance, which is a measure of electrode electronic conductivity. The loadings used were: PBX51 carbon black from Cabot Corp: 0.25 weight %; CNSF: 0.5 weight %; and SCNSF: 0.5 weight %. It was found that DC resistance could be reduced by blending CB with CNSF or with SCNSF. See FIG. 11A. CNSF (17% CNSs coating) showed the lowest DC resistance decrease relative to SCNSF (2% CNSs coating), a result suggesting that a carbon nanostructures coating is beneficial for improving DCA. According to FIG. 11B, the DC resistances for the blends remained low and stayed consistent over the course of 5-day regenerative braking cycles, which potentially indicates good cycling performances.

Table 6 presents data for three formulations suggesting that the increase in porosity for CB/CNSF blends may be significant. In more detail, it was found that blending CNS fibers with CB can modify the pore structures for the electrode, and increase total porosity, which suggests that isolated pores (pores not accessible by mercury in the Hg intrusion characterization test or similarly electrolyte in the battery) are minimized in CB/CNSF blends.

TABLE 6

| | Med Pore Diameter | | |
|---|---|---|---|
| | (μm) | Porosity | BET |
| Additive | (Vol) | (%) | (m²/g) |
| PBX51 | 2.41 | 44.43 | 1.8 |
| PBX51 + CNSF | 2.16 | 56.22 | 1.6 |
| CNSF | 5.06 | 43.06 | 0.7 |

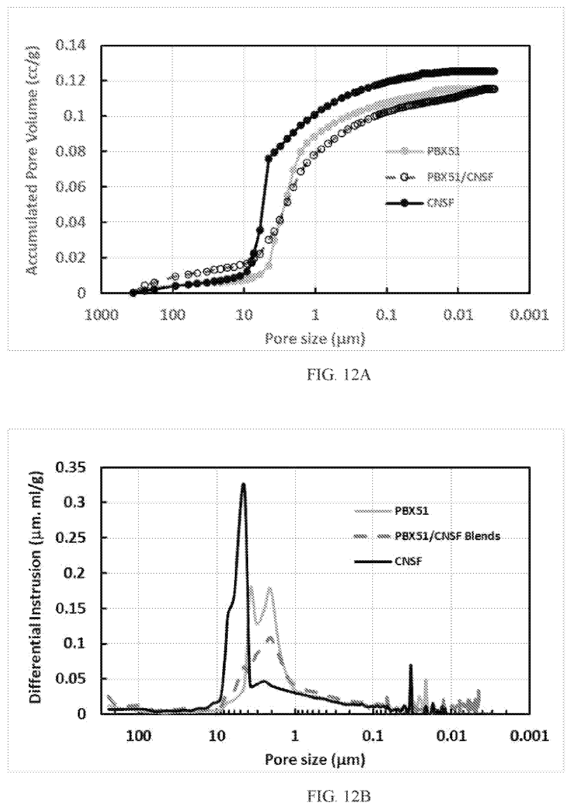

The accumulated pore volume and pore size distribution for these three formulations is shown, respectively, in FIGS. 12A and 12B.

Without wishing to be bound by a particular interpretation or mechanism, it is believed that a high effective carbon STSA in a NAM-containing paste (the effective STSA being expressed as: the carbon loading (%) multiplied by the carbon STSA (in m²/g)) contributes to both high DCA and water loss; that, in general, CNSs, alone or grown on glass fiber, improve lead utilization (e.g., at least 10% relative to CB); that NAM pore structure modification by fibers and electrode ohmic resistance reduction by CNS are the primary driving forces for high DCA performance.

It is also believed that the high DCA values obtained for a blend of CB and CNSF are brought about by: porosity enhancements, improved pore size distribution, increasing the volume of pores accessible to the electrolyte, and/or increased electrode conductivity (or a low DC ohmic resistance). Also, the fibers in the CNSF component may mitigate against the tendency of active materials to detach from the electrode during repeated particle growth and dissolution. Thus, the fibers in CNSF (and, also, in SCNSF) may improve the mechanical strength of the electrode, contribute to its integrity and potentially extend cycle life.

Even if mechanisms may not be entirely understood, DCA improvements observed with the carbon-based additives described herein may be related to: (i) an increase in the negative electrode active surface area (manifesting through depolarization of the negative electrode (electronic conductivity) and supercapacitive effect for high surface area carbon additives; (ii) formation of additional nucleation sites (the electrocatalytic effect), with the carbonaceous material facilitating the charge reaction PbSO₄→Pb by providing conductive surface area for Pb nucleation; (iii) modification of negative electrode morphology (physical barrier to prevent excessive PbSO₄ growth), as carbon particles affect the Pb/PbSO₄ crystallization, size of crystallites and/or the porosity of electrode.

Further embodiments of the invention relate to the “memory effect” or “history dependent DCA” often characterizing high DCA lead acid batteries. According to this phenomenon, the DCA performance is strongly influenced by the preceding short-term operating history, i.e., charge or discharge, prior to DCA pulses. Typically, the DCA is higher after discharge history and 2-10 times lower after charge history.

One school of thought regarding this phenomenon considers the amount and the size of lead sulfate (PbSO₄) particles as the key memory driver. It is widely accepted that during a preceding charging step, small PbSO₄ particles dissolve in the electrolyte first, and thus the remaining large PbSO₄ particles are considered the rate-determining step for the subsequent charge pulses (i.e., DCA) due to their inherent low solubility.

The so called “Ostwald ripening” further describes how small PbSO₄ particles can grow over time, substantially reducing the solubility in the electrolyte. Conversely, during a preceding discharge history, numerous small lead sulfate particles are being created upfront and then can be used for the charging DCA pulses. Therefore, a higher DCA is generally observed for discharge history than for the charge history.

It does not appear that current additives for NAM, or, more generally, current battery designs have been capable of changing this behavior.

Surprisingly, however, it was discovered that the memory effect (or history dependent DCA) was negligible for compositions combining NAM and certain carbon materials, CNSs, for instance. It was found that electrodes containing CNSs showed not only much higher DCA (1.5˜2A/Ah) for both Ic and Id, (relative to electrodes using CB at the same effective STSA), but also displayed a low, sometimes a barely noticeable difference between Ic and Id.

More generally, lead acid batteries with NAM-CNSs electrodes can have both Ic and Id that are greater than 0.5 A/Ah, e.g., at least 0.6, at least 0.8, at least 1.0, at least 1.2, at least 1.4, at least 1.6, at least 1.8, or at least 2 A/Ah. In one implementation, Ic is greater than 1.5 A/Ah and Id is greater than 2.0 A/Ah. For example, Ic can be greater than 1.6, than 1.7, than 1.8, than 1.9, than 2/Ah, while Id can be greater than 2, than 2.1, than 2.2, than 2.3, than 2.4, than 2.5 A/Ah.

The ratio of Id to Ic (Id/Ic) can be within a range of from about 1 to about 1.5, e.g., from about 1 to about 1.1, from about 1 to about 1.2, from about 1 to about 1.3, from about 1 to about 1.4; or from about 1.1 to about 1.2, from about 1.1 to about 1.3, from about 1.1 to about 1.4, from about 1.1 to about 1.5; or from about 1.2 to about 1.3, from about 1.2 to about 1.4, from about 1.2 to about 1.5; or from about 1.3 to about 1.4, from about 1.3 to about 1.5; or from about 1.4 to about 1.5.

A suitable technique for characterizing lead acid batteries described herein is based on EN 50342-6: 2015 Section 7.3 and is described in Example 19 below. According to this procedure, Ic and Id (DCApp pulse profile) are measured at 80% SOC with charge or discharge history, respectively. The ΔSOC (upfront charge or discharge SOC changes) is no greater than 20%. Batteries characterized in this manner can display Ic and Id values greater than 1.5 A/Ah and 2.0 A/Ah, respectively, with a difference between Ic and Id that is no greater than 50%. Ic and Id values at 80% SOC and ΔSOC of 10% can both be higher than 1.5 A/Ah and within 15% or less of one another.

Further observations seemed to indicate that the CNSs-NAM structures continued to evolve during charge pulses in a positive way; accordingly, DCA could continue to increase over the battery lifetime.

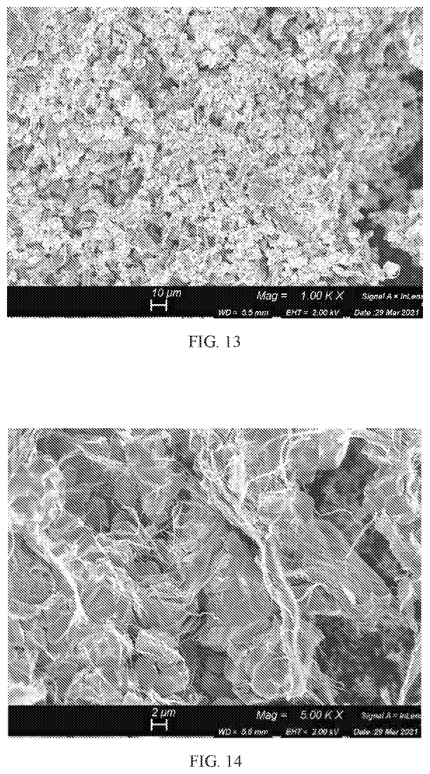

Without wishing to be bound by a particular interpretation of these findings, it is possible that CNSs (having a cross-linking and/or branched carbon nanotube morphology) can cover and connect individual particles in a way that not only provides a conductive network for the electrodes but can also act as a physical barrier to limit the growth/expansion of lead/lead sulfate particles. In other words, particle size distribution for cycled NAM-CNSs materials is small or close to mono-dispersed as shown in FIG. 13, while for other types of carbon additives, the particle size distribution is broad or even multimodal. If mono-dispersed particles dominate in the electrode, charge or discharge history is no longer relevant as all particles have a similar solubility (or size).

In addition, the Ostwald ripening effect can be minimized as particle growth is physically constrained by the crosslinked and branching structures of CNS. This is indicated by the red arrows in FIG. 14 (a SEM image for a CNS-NAM electrode). In more detail, the SEM image in FIG. 14 shows branched CNS material covering and connecting particles, forming a percolated carbon network. The red arrows mark the barriers formed by the CNS material, barriers that surround the NAM particles, physically barricading the particle from growth. Some bundled CNS material may be present in the NAM, which is believed to be dispersed and not forming agglomerates through multiple charge/discharge cycles (particle dissolution and reprecipitation) when the battery is in use. This mechanism may also explain why DCA increases during charging pulses segments as more conductive area/reaction sites can be readily available to accept charges over cycling.

It is also possible that the pore size and porosity of CNSs in NAM-containing compositions are unique in a way that can better transport electrolyte in and out of the electrodes due to the nature of high aspect ratio and branching characterizing CNSs. In other words, electrolyte equilibrium can be achieved in a short period of time so that the environment is readily available for more lead sulfate dissolution. In general, high electrolyte density or high sulfate ion concentration is formed after charge, the opposite taking place post discharge. Thus, after charging history, the high sulfate ion condition prevents lead sulfate dissolution due to common ion effect, resulting in low DCA. It may be critical, therefore, to transport sulfate ion from the interior to the electrode surface so that lead sulfate dissolution can continue to occur even inside the electrode. The network formed by the CNS material may be critical for ion transportation, especially for thick electrodes (2-3 mm). This may not be the case for other carbon additives, e.g., carbon blacks, where channels may become obstructed or blocked, rendering the electrolyte equilibrium more difficult to achieve.

Memory effect trends described herein with respect to CNSs may also be found for electrodes that employ CNSF and/or SCNSF materials, or for blends that utilize CNSs, CNSF and/or SCNSF in combination with CB, CNTs and so forth. Desirable effects on history dependent DCA also may be found when combining NAM with CNTs.

Furthermore, desirable history dependent DCA results often are observed at relatively modest carbon loadings. CNSs, for instance, can be employed in an amount of about 3 wt % or below, often less than or equal to 2.5, 2, 1.5, 1, 0.5 wt % or even less, e.g., less than or equal to 0.45, 0.4, 0.35, 0.3, 0.25, 0.2, 0.15 or 0.1 wt %. With respect to ranges, CNSs can be present in an amount within a range of from about 0.1 to about 0.5, from about 0.1 to about 1, from about 0.1 to about 1.5, from 0.1 to about 2., from about 0.1 to about 2.5, from about 0.1 to about 3; or from about 0.5 to about 1, from 0.5 to about 1.5, from about 0.5 to about 2, from about 0.5 to about 2.5, from about 0.5 to about 3; or from about 1 to about 1.5, from about 1 to about 2, from about 1 to about 2.5, from about 1 to about 3; or from about 1.5 to about 2, from about 1.5 to about 2.5, from about 1.5 to about 3; or from about 2 to about 2.5, from about 2 to about 3; or from about 2.5 to about 3. Values in between or outside these specific ranges also can be selected.

The invention is further illustrated by the following non-limited examples.

### EXAMPLES

### Example 1—Preparation of Prewetted CB

Prewetting of carbon black by water is beneficial to improve carbon dispersibility in the paste. The prewetted PBX®51 carbon black (a product of Cabot Corp.) was prepared by adding 12 g de-ionized water dropwise to manually stirred 5 g of PBX®51 carbon powder over the course of 5 minutes in a beaker. The ratio for water/CB in this prewetting step was 2.4. The prewetted PBX®51 was then ready to be mixed with other dry powders used for the paste mixing.

### Example 2—Preparation of a Controlled Sample Containing 0.5% PBX51 Carbon Additive in NAM

A mixing chamber is first charged with 1 kg leady oxide (HM-T grade, Product of Hammond Group. Inc. Hammon IN 46320), 5 g dry power for 0.5 wt % PBX®51 (prewetted according to Example 1), 2 g for 0.2 wt % Vanisperse DCA (a modified lignin-based additive, Borregaard Lignotech, Rothschild WI 54474), and 8 g for 0.8 wt % barium sulfate (Blanc Fixe F, product of Deutsche Baryt & Minerals Groton, MA 01450). The dry additive powders were mixed in the enclosed chamber for 5 minutes at a speed of 400 rotations per minute (rpm). 100 g de-ionized water is introduced to the dry mix by a ISMATEC® Ecoline peristaltic pump (a product of ISMATEC, a unit of IDEX Corp) at a rate of 6.67 g/min, pump speed scale set to “15”. The mixer was operated at a speed of 400 rpm during the course of water addition. After water addition, dry powder residues on the sidewall of the chamber were scraped down to mix with paste using a spatula to ensure homogeneous mixing. Then 112 g sulfuric acid (s.g.=1.40 or 50 wt %) was pumped into the paste mixture at an addition rate of 3 g/min to limit paste temperature from increasing beyond 60° C. The same mixer rotating speed of 400 rpm was also used for the acid addition. When finished, the sidewall was again scraped down and mixing was continued for another 25 minutes. This paste mixture was used as negative active materials (NAM) for negative electrodes.

### Example 3—Quality Control Methods for Paste Properties

Paste density was measured by Pycnometer method (fixed volume). A fixed volume cup (65.87 cc) was manually packed with paste made from example 2, and a spatula was used to smooth out the top surface of the paste to ensure the packed volume of the paste was close to the designated volume of the cup. The paste was then weighted. The paste density then calculated. Using the formula: paste density=paste weight (g)/65.87 cc, the paste density from example 2 was 4.09 g/cc.

Paste penetration was measured by Humbolt penetrometer. The tip of the probe was placed on the top surface of the paste then the probe was dropped to get the measurement in the unit of 1/10 mm. The penetration depth for the NAM paste from example 2 was 20 ( 1/10 mm).

Moisture content was measured by Halogen moisture analyzer (OHAUS, Model: MB35). For instance, 2-3 g of paste can be placed on the weighing pan and the test can be started at 130° C. for 20 minutes. The moisture content (MC) for the paste prepared according to Example 2 was 11.95%.

### Example 4—Preparation of a Paste for the Positive Electrode

A mixing chamber was charged with 1 kg leady oxide (HM-T grade, product of Hammond Group. Inc. Hammon IN 46320). 115 g de-ionized water was introduced to the leady oxide powder by a ISMATEC® ecoline peristaltic pump (product of ISMATEC, a unit of IDEX Corp.) at a rate of 6.67 g/min, pump speed scale set to “15”, and the mixer was operated at a speed of 400 rpm during the course of water addition. After water addition was completed, dry powder residues on the sidewall of the chamber were scraped down using a spatula to ensure uniform mixing. Then 112 g sulfuric acid (specific gravity of 1.40 or 50 vol %) was pumped into the mixture at a rate of 3 g/min to limit the temperature from increasing beyond 60° C. A mixer rotating speed of 400 rpm was also used for the acid addition. When finished, the sidewall was again scraped down and mixing was continued for another 25 minutes. The resulting paste mixture was used as positive active materials (PAM) for positive battery electrodes

### Example 5—Procedures for Applying NAM and/or PAM Pastes to Electrode Pb Grid

A paste prepared according to Example 2 was applied onto a Pb—Ca—Sn grid (Supplied by IEES-BAS, Institute of Electrochemical and Energy System, Bulgarian Academy of Science). The target NAM weight for the negative electrode was ˜23.5±0.5 g. The same approach was used for the PAM paste obtained according to Example 4. The target PAM weight for the positive electrode was ˜24.5±0.5 g

### Example 6—Electrode Curing Process

Pasted electrodes according to Example 5 were placed on a stainless steel rack and cured in an oven, specifically a Tenney Conditioning oven, Model T2RC. The curing protocol was set to 35° C. with chamber humidity of 85% for 72 hours followed by 60° C./10% for 24 hours. After cool down to ambient temperature, the electrodes were ready for assembly.

### Example 7—Assembly of a 2V Testing Cell

A testing cell was comprised of interdigitated two negative and three positive (2n-3p) electrodes. Solid rip profile separator from Daramic® was wrapped around positives with ribs facing positives. Lead posts used for external terminal connections were welded to either negative or positive plates. Pb solder material with high purity (>99.95%) was used to minimize contact resistance. The electrode set with separators (total thickness of ˜20 mm) along with four acid resistant shims (made of PP (polypropylene) material, each 2.8 mm thick) was squeezed in a polystyrene case (internal diameter=28 mm) so that the cell was under adequate compression to ensure cell testing reliability.

### Example 8—Readying the Cell for Testing

Before the formation step, 80 ml of sulfuric acid (specific gravity of 1.18) was added to the cell and the cell was allowed to sit for at least one hour to ensure that the electrolyte fully penetrated and soaked into the NAM, PAM and separator. After a formation step conducted according to a suitable protocol, the electrolyte was drained out fully and replaced with sulfuric acid solution having a specific gravity of 1.28 or 37 wt %. The cell was now ready for testing.

### Example 9

A NAM containing 0.5% CNSF (length=5 mm) or 0.5% SCNSF (length=5 mm) was prepared using the approach in Example 2, but replacing the 0.5% PBX®51 with 5 g of 0.5% CNSs fibers (CNSF) or 5 g of 0.5% spent CNSs fibers (SCNSF). The other additives in Example 2, namely barium sulfate, vanisperse DCA, were mixed with 1 kg leady oxide.

Two other batches of NAM (#3, #5) included blended CB with CNSF or CB with SCNSF were also prepared according to Example 2. For the paste mixing, 5 g of 0.5% PBX®51 (prewetted according to Example 1), and 5 g of 0.5% CNSF or of 0.5% SCNSF were mixed with 0.2% Vanisperse DCA, 0.8% barium sulfate and lead oxide. 5 g of de-ionized water was added to soften the paste so it could be easily handled and pasted on the lead grid.

The formulations tested are shown in the Table A below.

TABLE A

| | | | | | | Lead |
|---|---|---|---|---|---|---|
| | | | Density, | Penetration, | EN DCA, | Utilization, |
| # | Formulation | MC, % | g/cc | 1/10 mm | A/Ah | Ah/Kg |
| 1 | 0.5% PBX51 (example 2) | 11.95 | 4.09 | 20 | 0.36 | 158.9 |
| 2 | 0.5% CNSF | 13.4 | 3.6 | 18 | 0.44 | 175 |
| 3 | 0.5% PBX51 + 0.5% CNSF | 13.6 | 4.27 | 15 | 0.94 | 177.5 |
| 4 | 0.5% SCNSF | 10.45 | 3.55 | 31 | 0.4 | 168.3 |
| 5 | 0.5% PBX51 + 0.5% SCNSF | 14.35 | 3.9 | 19 | 0.87 | 160.3 |

The blended carbon black, PBX®51, with CNSF or with SCNSF showed significant improvement in DCA compared to carbon black (formulation #1), CNSF (formulation #2) or SCNSF (formulation #4) used separately in the NAM.

The other benefit that fibers brings is improving lead utilization. Compared to CB only formulations, fibers improve lead utilization by up to 11.7%. High lead utilization in lead acid battery suggests that less lead may be needed in the battery to deliver the same capacity. In turn, this brings about the benefits of low weight, low additive usage and thus reduces manufacturing costs. Also, CNSF was found to be more effective than SCNSF in terms of maintaining high lead utilization, which may be due to the higher conductive CNS coating on the fibers.

### Example 10

Different loadings of CNSF (length=5 mm) or SCNSF (length=5 mm) were evaluated for DCA improvement. Table B below shows formulations #2 and #4 made according to the protocol of Example 2, except for the addition of 5 g of de-ionized water that was added to modify the paste rheology. Even with low loading of fibers, the DCA improvement was significant compared to formulations that used the CB, CNSF of SCNSF material by itself. In addition, a similar trend was observed with respect to lead utilization which improved as the more conductive CNSF was added in the NAM.

TABLE B

| | | | | | | Lead |
|---|---|---|---|---|---|---|
| | | | Density, | Penetration, | EN DCA, | Utilization, |
| # | Formulation | MC, % | g/cc | 1/10 mm | (A/Ah) | Ah/Kg |
| 1 | 0.5% PBX51 + 0.5% CNSF | 13.6 | 4.27 | 15 | 0.94 | 177.5 |
| 2 | 0.5% PBX51 + 0.1% CNSF | 13.3 | 3.97 | 22 | 0.9 | 169.5 |
| 3 | 0.5% PBX51 + 0.5% SCNSF | 14.35 | 3.9 | 19 | 0.87 | 160.3 |
| 4 | 0.5% PBX51 + 0.1% SCNSF | 13.75 | 3.98 | 32 | 0.74 | 153.5 |

### Example 11

A short fiber (2 mm) SCNSF material was tested in a blend with 0.5% PBX®51 in NAM. Specifically, 1 g of 0.1% short CNSF was mixed with 5 g for 0.5% PBX®51 (prewetted as described in Example 1) and all other additives as described in Example 2. Both DCA and lead utilization were improved compared to SCNSF blends where the length of SCNSF was 5 mm. Specific values are shown in Table C.

TABLE C

| | | | | | | Lead |
|---|---|---|---|---|---|---|
| | | | Density, | Penetration, | EN DCA | Utilization, |
| # | Formulation | MC, % | g/cc | 1/10 mm | (A/Ah) | Ah/Kg |
| 1 | 0.5% PBX51 + 0.1% SCNSF (short) | 14.15 | 3.86 | 35 | 0.81 | 162.1 |

### Example 12

High CB loadings were tested for DCA improvement by blending with CNSF or SCNSF. Because the loading for this high surface area carbon is so high that more water will be adsorbed on the CB surface, the water needed during the water addition step in Example 2 was changed from 100 g to 110 g to ensure uniform mixing without any local paste segregations. The paste properties are shown below and DCA improvement was still valid at high loadings. The improvement as least 50%, in such high CB loadings. Fiber blend formulations also show improved lead utilization compared to formulations with CB by itself at this CB loading. Results are shown in Table D below.

TABLE D

| | | | | | | Lead |
|---|---|---|---|---|---|---|
| | | | Density, | Penetration, | EN DCA | Utilization, |
| # | Formulation | MC, % | g/cc | 1/10 mm | (A/Ah) | Ah/Kg |
| 1 | 1% PBX51 | 13.5 | 4.08 | 20 | 0.66 | 149.7 |
| 2 | 1% PBX51 + 0.5% CNSF | 13.7 | 3.98 | 10 | 1.16 | 166.2 |
| 3 | 1% PBX51 + 0.5% SCNSF | 14.3 | 3.74 | 12 | 0.99 | 154.9 |

### Example 13

This example describes the procedure to measure the porosity of the formed electrode. Toward this goal, the formed electrodes for formulations (#1through #3) in example 9 were disassembled from the cell case. As the formed electrode was mainly lead particles which are subject to oxidation in the air, anhydrous ethanol (manufactured by Alfa Aesar) was used to prevent lead oxidation. To remove residual sulfuric acid in the NAM, the NAM was left in dehydrated ethanol solution for at least 30 minutes followed by pH measurement. The ethanol solution was decanted, followed by refilling with fresh ethanol to effectively decrease sulfuric acid concentration. This step was repeated and the pH measured multiple times until reaching a neutral pH. The NAM was then soaked in 1.5% steric acid in ethanol for at least 24 hours. NAM electrode with residual ethanol was dried in vacuum at 60° C. under a nitrogen atmosphere for at least 12 hours. At this point, the electrode was ready for mercury porosity measurements. FIG. 12B shows the pore size distribution of NAM with different compositions. Compared to carbon black or CNSF used separately, the blended formulation showed a wider distribution of pore size, which is beneficial for electrolyte accessibility and is thought, therefore, to improve DCA in lead acid battery.

### Example 14

PBX®09 with a BET of approximately 210-260 m²/g, STSA of approximately 140-180 m²/g, and OAN of approximately 100-130 m²/g (from Cabot Corp.) was used to blend with CNSF and evaluated with respect to DCA improvements. Two formulations were tested for NAM produced according to the protocol set out in Example 2. The formulations were: (1) 10 g of 1% PBX®09; and (2) 10 g of 1% PBX®09 blended with 5 g of 0.5% CNSF. The paste properties and EN DCA performance are shown in Table E below. CNSF blends were found to significantly improves DCA (by 24%).

TABLE E

| | | | | | | Lead |
|---|---|---|---|---|---|---|
| | | | Density, | Penetration, | EN DCA | Utilization, |
| # | Formulation | MC, % | g/cc | 1/10 mm | (A/Ah) | Ah/Kg |
| 1 | 1% PBX09 | 13.6 | 3.95 | 38 | 0.5 | 156.1 |
| 2 | 1% PBX09/0.5% CNSF blends | 13.45 | 3.74 | 15 | 0.62 | 147.4 |

### Example 15

CNSs (carbon nanostructures free of growth substrates) with a BET of about 210-250 m²/g and STSA of 200-260 m²/g (product of Cabot Corp.) was used in a blend with CNSF and evaluated with respect to DCA. Two NAM formulations were prepared according to the protocol of Example 2, using: 1) 5 g of 0.5% CNSs; and 2) 5 g of 0.5% CNSs blended with 5 g of 0.5% SCNSF. The paste properties and EN DCA performance are shown in Table F below. SCNSF blends significantly improved DCA (by 37%). The SCNSF also showed high lead utilization in this CNS formulation, which suggests that CNSs dominate the lead utilization while adding SCNSF does not impair battery lead utilization performance.

TABLE F

| | | | | | | Lead |
|---|---|---|---|---|---|---|
| | | | Density, | Penetration, | EN DCA | Utilization, |
| # | Formulation | MC, % | g/cc | 1/10 mm | (A/Ah) | Ah/Kg |
| 1 | 0.5% CNS | 13.15 | 3.88 | 12 | 0.67 | 180 |
| 2 | 0.5% CNS/0.5% SCNSF blends | 12.5 | 4.34 | 10 | 0.92 | 180.2 |

### Example 16

This example compared two formulations with the same additive concentration, but in a different from. The details are shown in Table G. It is believed that CNSF literally can be separated into CNS and SCNSF. The result clearly showed that the DCA was similar while the lead utilization suffered if conductive CNS is separated from fibers. Thus, it can be concluded that a conductive CNS coating is essentially on the fiber to achieve both DCA and utilization performance.

TABLE G

| | | | | | | Lead |
|---|---|---|---|---|---|---|
| | | | Density, | Penetration, | EN DCA | Utilization, |
| # | Formulation | MC, % | g/cc | 1/10 mm | (A/Ah) | Ah/Kg |
| 1 | 0.5% PBX51/0.5% CNSF blends | 13.6 | 4.27 | 15 | 0.94 | 177.5 |
| 2 | 0.5% PBX51/0.5% (CNS + SCNSF) | 12.35 | 4.04 | 22 | 0.92 | 163.3 |
| | blends | | | | | |

### Example 17

1.5% PBX®51 in NAM was prepared following procedures in Example 2. In addition to the prewet water of 36 g used (for prewetting), a total of 140 g of DI water was used during water addition step. Excess water is believed to improve the quality of paste rheology, an important attribute for paste handling during grid pasting (as shown in Example 5). High PBX®51 loadings led to high effective STSA, and therefore high DCA. Adding CNSF improved lead utilization while blends using GF, glass fibers, or silicate fibers (product of Hollingsworth & Vose) significantly reduces DCA and lead utilization. The results are shown in Table H.

TABLE H

| | | | | | | Lead |
|---|---|---|---|---|---|---|
| | | | Density, | Penetration, | EN DCA | Utilization, |
| # | Formulation | MC, % | g/cc | 1/10 mm | (A/Ah) | Ah/Kg |
| 1 | 1.5% PBX51 | 14.1 | 3.8 | 9 | 1.1 | 148 |
| 2 | 1.5% PBX51/0.5% CNSF | 14.75 | 3.83 | 13 | 0.97 | 153.5 |
| | blends | | | | | |
| 3 | 1.5% PBX51/0.5% glass | 14.1 | 3.73 | 14 | 0.78 | 143.75 |
| | fiber | | | | | |
| 4 | 1.5% PBX51/0.1% silicate | 14.65 | 3.73 | 24 | 0.76 | 145.3 |
| | fibers | | | | | |

### Example 18

Three component blends, containing CB, CNS, and SCNSF were prepared using the approach of Example 2. Low CB loading of 0.375% in combination with CNS and SCNSF was found to also achieve high DCA and high lead utilization compared to blends with high CB loading, for example 0.5%. The data is presented in Table I below.

The benefits of this loading of CB is potentially to reduce water loss. It has been known in the lead acid battery industry that high effective STSA (carbon loading, %)×(carbon STSA, m²/g) is the key driver to high water loss. This illustrates that DCA can be maintained at lower STSA, which potentially mitigates water loss performance.

TABLE I

| | | | | | | Lead |
|---|---|---|---|---|---|---|
| | | | Density, | Penetration, | EN DCA | Utilization, |
| # | Formulation | MC, % | g/cc | 1/10 mm | (A/Ah) | Ah/Kg |
| 1 | 0.375% PBX51/0.125%CNS/ | 12.85 | 4.11 | 10 | 0.86 | 168.7 |
| | 0.25% SCNSF | | | | | |
| 2 | 0.375% PBX51/0.25%/0.1% | 15.35 | 3.75 | 30 | 0.93 | 172.9 |
| | SCNSF | | | | | |

### Example 19

Experiments were performed to compare the DCA performances for electrodes incorporating PBX®51 carbon black (BET of 1300-1550 m²/g and STSA of 450-600 m²/g) and CNSs (carbon nanostructures free of growth substrates, having a BET of about 210-250 m²/g and STSA of 200-260 m²/g), both from Cabot Corp.

Loadings of 0.5% and 1.25% are used for PBX®51 (STSA=576 m²/g) and CNS (STSA=230 m²/g), respectively. As discussed above, DCA depends on the “effective STSA” and high DCA values trend with high carbon effective STSA. Therefore, in this example, the “effective STSA”, namely [(carbon loading (%)]×[carbon STSA (m²/g)] is matched (kept the same or substantially the same) for the two additives: 0.5×576 for the PBX®51 carbon black and 1.25×230 for the CNS material. (Other loadings can be employed for the comparison. For example, 0.25% PBX®51 and 0.625% CNS have the same STSA.)

Electrode preparation and cell assembly were conducted as described in previous examples.

The state of charge (SOC) is defined and calculated based on nominal capacity using an active material utilization of 110 Ah/Kg. For example, a cell with nominal capacity of 5 Ah is defined as 100% SOC; therefore, discharging the cell with a capacity of 6 Ah would indicate −20% SOC.

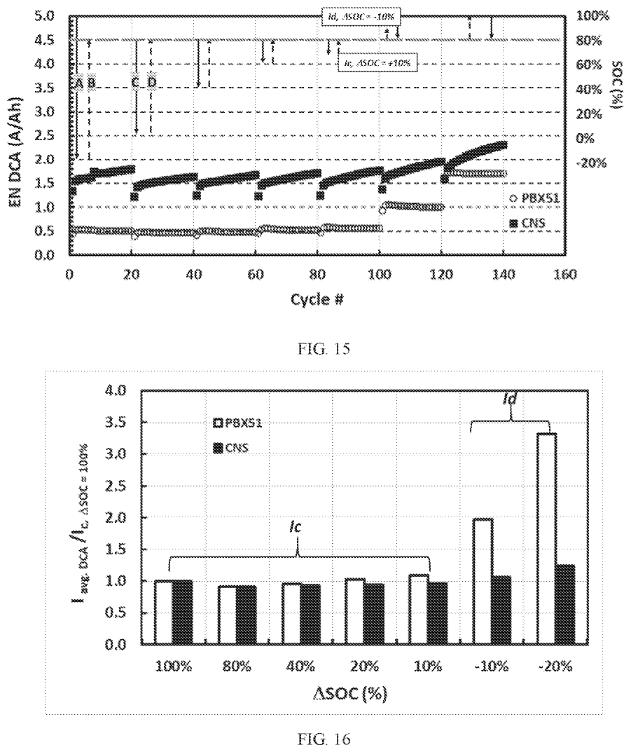

The testing protocol was based on the EN50342-6:2015 publication, following the testing sequence described below:
(a) Cell formation
(b) Pre-cycling: EN50342-6: 2015 Section 7.3 (Table 10)
(c) Charge/Discharge history: Starting with 100% SOC and discharge to −20% SOC (Path A in FIG. 15), followed by charging to 80% SOC (Path B in FIG. 15). Detailed charge or discharge procedure in this step was based on EN50342-6:2015 (Table 11). The end SOC for all segments was at 80% before performing DCApp, to avoid variability due to SOC differences.
(d) Rest: 20 hrs.
(e) DCApp test: EN50342-6: 2015 Section 7.3 (Table 12). Twenty charge pulses were included in this test. DCA for cycle #1-#20 was recorded.
(f) Steps (c) to (e) were repeated but following path “C” and “D” for cycle #21-40; the remaining sequence was continued (cycle #41-cycle #140) as shown in FIG. 15 at various ΔSOC.

It is noted that Steps (c) to (e) are considered “charge history” as DCApp is performed right after charging, path B, and 20 hrs rest.

In FIG. 15, DCA for the PBX®51 sample is about 0.5 A/Ah for Ic history (up to 100 cycles) regardless of the degree of SOC swings (i.e., ΔSOC). It is also found that Id (i.e. 1-2 A/Ah, cycle 101-140) is several times higher than Ic (cycle 1-100) and much more ΔSOC dependent. The higher the ΔSOC for the Id, the higher the DCA. The fact that Id is higher than Ic is not unexpected, as this behavior has been recognized and explained in the past.

It was surprising, however, that electrodes incorporating CNSs showed not only much higher DCA (1.5-2.5 A/Ah) for both Ic and Id, given the similar effective STSA as that of the PBX®51 sample, but also that the difference between Ic and Id was barely observed. This suggests that the memory effect or history dependent DCA performance is negligible for CNSs-containing NAM electrodes.

Moreover, the DCA for each DCApp segments (e.g. cycle #1˜cycle 20) at ΔSOC=100% increases gradually for NAM+CNSs, while it plateaus for NAM+PBX®51. This suggests that the NAM structure for the CNSs-containing material continued to evolve during charge pulses in a positive way, and that DCA can continue to increase over battery lifetime. The implication for real life battery application is that the battery could maintain high DCA performances without concern about user history.

To better illustrate this effect, DCA pulses from each segment were averaged and normalized with respect to the baseline (i.e., ΔSOC=100%) in FIG. 16. For example, DCA from cycle #81-100 was averaged, normalized and defined as Ic (charge history) with ΔSOC of +10% (SOC_{END}−SOC_{START}=80%-70%), while cycle #101-120 was defined as Id (discharge history) with ΔSOC of −10% (SOC_{END}−SOC_{START}=80%-90%). The figure clearly shows that with the same SOC swing, i.e., +10% or −10%, Id is ˜2 times higher than Ic for PBX®51/NAM while it is only ˜15% higher for CNS/NAM. This trend is even more pronounced as the ΔSOC increases to 20% so that Id is ˜250% higher than Ic (Id/Ic=3.5) for PBX®51/NAM and only about ˜30% higher (Id/Ic=1.3) for CNS/NAM.

As the battery is constantly experiencing a charging and discharging history over the course of its lifetime, especially for micro-hybrid application, the lack of memory effect is an important consideration for lead acid battery to be competitive relative to other technologies, for example, Li ion batteries.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While this invention has been particularly shown and described with references to preferred embodiments thereof, it will be understood by those skilled in the art that various changes in form and details may be made therein without departing from the scope of the invention encompassed by the appended claims.

1. An electrode composition, comprising:
a negative active material for a lead acid battery; and
a carbon-based additive including a first constituent selected from the group consisting of carbon nanostructures free of a growth substrate, a substrate-containing carbon nanostructure material, and any combination thereof, and a second constituent selected from the group consisting of carbon black, conventional carbon nanotubes and any combination thereof,
wherein the carbon nanostructures include a plurality of multiwall carbon nanotubes that are crosslinked in a polymeric structure by being branched, interdigitated, entangled and/or sharing common walls.

2. The electrode composition of claim 1, wherein:
at least one of the multiwall carbon nanotubes has a length equal to or greater than 2 microns, as determined by SEM,
at least one of the multiwall carbon nanotubes has a length to diameter aspect ratio within a range of from 200 to 1000,
there are at least two branches along a 2-micrometer length of at least one of the multiwall carbon nanotube, as determined by SEM,
at least one multiwall carbon nanotube exhibits an asymmetry in the number of walls observed in the area after a branching point relative to the area prior to the branching point, and/or
no catalyst particle is present at or near branching points, as determined by TEM.

3. The electrode composition of claim 1, wherein the multiwall nanotubes include 2 to 30 coaxial nanotubes, as determined by TEM at a magnification sufficient for counting the number of walls.

4. The electrode composition of claim 1, wherein at least 1% of the carbon nanotubes have a length equal to or greater than 2 microns, as determined by SEM,
a length to diameter aspect ratio within a range of from 200 to 1000, and/or exhibit an asymmetry in the number of walls observed in the area after a branching point relative to the area prior to the branching point.

5. The electrode composition of claim 1, further comprising carbon nanostructure fragments and/or fractured multiwall nanotubes.

6. The electrode composition of claim 1, wherein the second constituent comprises a carbon black having a STSA within a range of from about 40 to about 700 m²/g.

7. The electrode composition of claim 1, wherein the second constituent comprises a carbon black having a STSA within a range of from about 500 to about 600 m²/g and/or a carbon black having a STSA within a range of from about 100 to about 200 m²/g.

8. The electrode composition of claim 1, wherein the carbon-based additive has an effective STSA within a range of from about 0.1 to about 8 m²/g.

9. The electrode composition of claim 1, wherein the carbon-based additive has an effective STSA within a range of from about 0.1 to about 5 m²/g.

10. The electrode composition of claim 1, wherein the second constituent comprises a carbon black which is present in a blend of carbon blacks, the carbon blacks in the blend being characterized by different STSAs.

11. The electrode composition of claim 1, wherein the substrate-containing carbon nanostructure material comprises carbon nanostructures in an amount within a range of from about 0.5 to about 20 weight %.

12. The electrode composition of claim 1, wherein the substrate-containing carbon nanostructure material comprises carbon nanostructures in an amount within a range of from about 0.5 to about 5 weight % or in an amount within a range of from 5 to 20 weight %.

13. The electrode composition of claim 1, wherein the substrate-containing carbon nanostructure material comprises fibers in an amount within a range of from about 70 to about 99 weight %.

14. The electrode composition of claim 1, wherein the substrate-containing carbon nanostructure material is selected from the group consisting of carbon nanostructure fibers, spent carbon nanostructure fibers, and any combinations thereof.

15. The electrode composition of claim 14, wherein the carbon nanostructures, the carbon nanostructure fibers and/or the spent carbon nanostructures fibers include a coating.

16. The electrode composition of claim 1, wherein the ratio of the first constituent to the second constituent is within a range of from about 0.1 to about 5.

17. The electrode composition of claim 1, wherein, when dried, the electrode composition comprises the carbon-based additive in an amount no greater than about 10% by weight.

18. The electrode composition of claim 1, wherein, when dried, the electrode composition comprises the carbon-based additive in an amount within a range of from about 0.1 to about 3% by weight relative to PbO.

19-25. (canceled)

26. An electrode composition, comprising:
a negative active material for a lead acid battery; and
a carbon-based additive including carbon nanostructures and, optionally, a component selected from the group consisting of carbon black, conventional carbon nanotubes and any combination thereof,
wherein the carbon nanostructures include a plurality of multiwall carbon nanotubes that are crosslinked in a polymeric structure by being branched, interdigitated, entangled and/or sharing common walls.

27-59. (canceled)

60. An electrode, comprising:
negative active materials for a lead acid battery and carbon nanostructures,
wherein the carbon nanostructures include a plurality of multiwall carbon nanotubes that are crosslinked in a polymeric structure by being branched, interdigitated, entangled and/or sharing common walls.

61-79. (canceled)
